(19) United States
(12) Patent Application Publication
(10) Pub. No.: US 2025/0238977 A1
(43) Pub. Date: Jul. 24, 2025

(54) Method for Providing Information about Angiography and Device Using the Same

(71) Applicant: Industry-Academic Cooperation Foundation, Yonsei University, Seoul (KR)

(72) Inventors: Kyu Bom Kim, Seoul (KR); Kyu Seok Kim, Seoul (KR); Su Hwan Lee, Seoul (KR); Yeon Kyeong Kim, Seoul (KR)

(73) Assignee: Industry-Academic Cooperation Foundation, Yonsei University, Seoul, SE (KR)

(21) Appl. No.: 19/032,586

(22) Filed: Jan. 21, 2025

(30) Foreign Application Priority Data
Jan. 24, 2024 (KR) 10-2024-0011170
Jan. 24, 2024 (KR) 10-2024-0011171

(51) Int. Cl. G06T 11/00; G06T 7/00; G06V 10/40

(52) U.S. Cl. CPC G06T 11/003; G06T 7/0012; G06V 10/40; G06T 2207/20081; G06T 2207/30101

(57) ABSTRACT

In the present specification, as an information providing method for angiography which is implemented by a processor, an information providing method for angiography including a step of receiving a projection image of a computed tomography angiography (CTA) of an individual, a step of generating a first extraction image for a blood vessel by inputting the received CTA projection image to a first model which is trained to generate a first extraction image for the blood vessel with a CTA projection image as an input, and a step of generating a rendering image from the first extraction image.

### CROSS-REFERENCE TO RELATED APPLICATIONS

This application claims the priority of Korean Patent Application No. 10-2024-0011170, No. 10-2024-0011171 filed on Jan. 24, 2024, in the Korean Intellectual Property Office, the disclosure of which is incorporated herein by reference.

### BACKGROUND

### Technical Field

The present disclosure relates to a method for providing information about angiography and a device using the same.

### Discussion of the Related Art

Vascular disease is one of the problems that threatens the health of the people in a super-aging society, and in particular, cerebrovascular disease is one of the five major causes of death. The number of patients with unruptured cerebral aneurysms in Korea is rapidly increasing from 70,828 in 2016 to 143,808 in 2021, making periodic follow-up observations essential. In addition, the angiographic imaging device market is expected to grow significantly at an average growth of 8.8% from approximately USD 46 million in 2022 to approximately USD 70 million in 2027.

A method for examining vascular diseases is divided into an invasive method and a non-invasive method. The invasive method includes a digital subtraction angiography (DSA) and the non-invasive method includes a computed tomography angiography (CTA) and a magnetic resonance angiography (MRA). The non-invasive angiographic device typically acquires a projection image (CTA or MRA) using X-rays after injecting contrast media to acquire an image by means of postprocessing. Specifically, as compared with the MRA, the CTA has a short imaging time and no imaging restrictions on a metal material so that the CTA is widely used.

To be more specific, the CTA is obtained by selectively imaging only a blood vessel by reconstructing an image obtained in an arterial dominant phase in 3-dimensions after rapid intravenous injection of the contrast agent. Therefore, the contrast of the blood vessel is improved more than surrounding tissues by means of the contrast enhancement to acquire a blood vessel image. In the meantime, the CTA acquires images before/after the contrast agent and then extracts a blood vessel image by subtracting the image, but is vulnerable to various external variables, such as double covering or patient's movement. When an artifact caused by the variables is corrected and subtracted, there is a limitation that high density surgical information (coling or slipping) is lost.

With regard to this, the CTA mainly uses iodinated contrast agents to increase the contrast of blood vessels. However, the iodinated contrast used for the CTA may cause various side effects. The side effects include local or systemic allergic reactions such as anaphylaxis, adverse reactions in the cardiovascular and renal systems, and symptoms that can lead to fatal results such as extravasation.

Moreover, it has recently been reported that when a contrast agent is used together with radiation of X-ray, the number of damaged DNAs increases compared to when a contrast agent is not used. That is, when the washout of the contrast agent is not sufficiently performed in the radiation treatment, the contrast agent may adversely affect the radiation treatment so that the use of a contrast agent with a low concentration is emerging.

Therefore, as an alternative to iodinated contrast agents, nonionic contrast agents with low osmotic pressure are being used, but they have the limitation of being difficult to maintain maximum contrast enhancement. Further, in order to overcome the low contrast duration and toxicity of a currently used low-molecular-weight contrast agent, an iodine contrast agent based on a high-molecular-weight compound is being developed. However, there is insufficient evidence to verify a stability through clinical trials and prove characteristics (an amount, a density, and an injection speed) of the contrast agent which causes maximum vascular contrast in a region of interest.

Moreover, beam hardening on a high-density material, such as bones may cause loss of information about the blood vessel in a radiation path, which makes accurate diagnosis difficult. Accordingly, there is a continuous demand for development to overcome the limitation of double covering of CTA and information loss as described above.

The background of the present disclosure is described for easier understanding of the present disclosure. It should not be understood to admit the matters described in the background of the present disclosure as a prior art.

### SUMMARY

A contrast agent reduction method in a CTA of the related art includes an optimization method for a contrast agent injection speed and an imaging condition, a contrast agent reduction method based on a dual energy, a polymer compound-based iodinated contrast agent development and a deep-learning-based contrast agent reduction method.

To be more specific, the optimization method for a contrast agent injection speed and an imaging condition (hereinafter, referred to as a contrast agent optimization method) is a method of optimizing a contrast effect according to an amount, a concentration, an injection speed, and a tube voltage of iodinated contrast agent based on an HU value in each organ and may reduce the contrast agent only by changing a protocol of the CTA, but has an insignificant reduction rate. Further, the CTA method of the related art is performed in the same manner so that the contrast agent optimization method has limitations of doubling covering, an artifact error due to movement, treatment information loss for a high-density material, and information loss due to beam hardening.

Next, the dual energy-based contrast agent reduction method is a method based on a characteristic that a linear attenuation coefficient changes according to radiation energy for every material. Therefore, after acquiring low/high energy images, a difference of linear attenuation coefficients between the materials at every energy is reflected to separate materials. According to the dual energy-based contrast agent reduction method, a contrast agent signal in a blood vessel is increased by a maximum K-edge reaction on iodine by setting the low tube voltage to reduce the requested amount of contrast agent. However, it has limitations in that the contrast agent reduction rate is insignificant, and the development cost is higher than that of the CTA of the related art. Further, the dual energy-based contrast agent reduction method still has a limitation of data loss due to a high-density material and the beam hardening.

Next, recently, in order to overcome the limitation on the low molecular weight contrast agent compound containing iodine of the related art, a contrast agent for radial polymer compound containing iodine is being developed. To be more specific, the polymer compound-based iodinated contrast agent development method includes a longer contrast duration than that of the contrast agent of the related art, low toxicity, low adverse reaction, and a simple producing (cleaning) method, but a clinical usefulness thereof has not yet sufficiently examined and the limitations on the data loss due to the high density material and the beam hardening still remain.

Next, as the deep-learning-based contrast agent reduction method, a deep-learning-based method which is trained based on a CTA image for a normal contrast agent dose and a CTA image for a low contrast agent dose has been reported. However, it has a limitation that it is difficult to accurately predict because it is difficult to secure a large amount of refined data for pre-training, so that machine learning is not sufficiently trained.

That is, as described above, the methods of the related art have low accuracy and reliability for the angiographic image due to the beam hardening. Currently, various methods for correcting the image for a low contrast agent and beam hardening have been tried, but there are limitations such as inclusion of virtual information, a high development cost, information loss of a high-density treatment, a reconstruction limitation, and acquisition of training data.

Moreover, the CTA imaging method includes a direct subtraction method, a dual energy-based material separation method, and a deep-learning-based method.

To be more specific, the direct subtraction method is the most generally used method, among CTA imaging methods. According to the direct subtraction method, a primary imaging (pre-contrast CT) is performed before the contrast agent reaches a region of interest and a secondary imaging (post-contrast CT) is performed when the contrast agent shows maximum contrast enhancement in the region of interest to acquire two CT images and subtract two acquired images, thereby finally acquiring a blood vessel image. Such a direct subtraction method has an advantage of acquiring the blood vessel image without using additional equipment but has limitations such as an artifact loss due to the double covering and movement for two imaging processes, loss of treatment information using a metal material, and information loss due to beam hardening.

Next, the dual energy-based material separation method is a method based on a characteristic that a linear attenuation coefficient of materials changes according to an energy. Therefore, after acquiring low/high energy images, a difference of linear attenuation coefficients between the materials at every energy is reflected to separate materials. This method is used to remove information about a bone having an image intensity similar to the contrast agent, and then apply a threshold value to extract a blood vessel. Recently, in order to extract a blood vessel through single imaging, a CT system which uses a sandwich detector (SD) or a photon counting detector (PCD) after injecting the contrast agent has been developed. However, the development cost thereof is higher than that of a normal CTA method and like the direct subtraction method, there are still limitations of treatment information using a metal material and information loss by the beam hardening.

In recent years, various deep-learning-based methods which are trained based on a secondary image (post-contrast CT) which is imaged when the contrast agent shows maximum contrast enhancement in the region of interest have been announced, but there is a limitation in that it is difficult to ensure a plurality of data cleaned for pre-training.

That is, as described above, the methods of the related art have low accuracy and reliability for the angiographic image due to the beam hardening. Currently, various methods for correcting beam hardening have been tried, but there are limitations such as inclusion of virtual information, a high development cost, information loss of a high-density treatment, a reconstruction limitation, and acquisition of training data.

In the meantime, inventors of the present disclosure recognized that when a calibration phantom reflecting various thicknesses of blood vessels and a computer simulation system based on this were used, various CTA projection images according to a concentration were obtained and machine learning was trained based on this. That is, the inventors of the present disclosure recognized that with regard to a machine learning method of the related art, a limitation on training data was overcome by CTA system modeling using a calibration phantom and computer simulation and discovered that various medical images similar to reality were generated by computer simulation modeling.

Further, the inventors of the present disclosure discovered that when data about blood vessels and data about treatments were separately extracted and then registered to generate a rendering image, the blood vessel and medical procedure data were more precisely extracted even with a single imaged image and an error caused by the beam hardening of the related art was reduced.

As a result, the inventors of the present disclosure developed a method for providing information about an angiography which generated a CTA projection image for every actual contrast agent concentration by a calibration phantom to which various blood vessel thicknesses were reflected, acquired various CTA projection images, like an actual clinical image, by reflecting the CTA projection image to the computer simulation system to train a machine learning model at every concentration based on this, and generate a 3D rendering image with a CTA projection image for a low concentration contrast agent using the trained machine learning model at every concentration.

Moreover, the inventors of the present disclosure discovered that when data about blood vessels and data about treatments were separately extracted and then registered to generate a rendering image, the blood vessel and medical procedure data were more precisely extracted even with a single-imaged image and an error caused by the beam hardening of the related art was reduced. Further, the inventors of the present disclosure recognized that with regard to a machine learning method of the related art, a limitation on training data was overcome by CTA system modeling using computer simulation and discovered that various medical images similar to reality were generated by computer simulation modeling.

As a result, the inventors of the present disclosure developed a method for providing information about an angiography which separated blood vessel and high-density medical procedure data based on single imaging in a CTA system and generated various reconstruction images based on this.

Therefore, an object to be achieved by the present disclosure is to provide a method for providing information about an angiography based on machine learning which overcomes side-effect of the contrast agent, double covering, and beam hardening described above and a device using the same.

Another object to be achieved by the present disclosure is to provide a method for providing information about an angiography based on machine learning which overcomes side-effect of the double covering, and beam hardening described above and a device using the same.

Objects of the present disclosure are not limited to the above-mentioned objects, and other objects, which are not mentioned above, can be clearly understood by those skilled in the art from the following descriptions.

In order to achieve the above-described objects, the present disclosure provides an information providing method for angiography which is implemented by a processor, including a step of receiving a computed tomography angiography (CTA) projection image of an individual and CTA contrast agent concentration data; a step of selecting one of first models at every contrast agent concentration trained to generate a first extraction image for a blood vessel with a projection image for CTA as an input based on the contrast agent concentration data; a step of generating a first extraction image by inputting the received projection image to the selected first model; and a step of generating a rendering image from the first extraction image.

According to a feature of the present disclosure, the information providing method may further include a step of receiving clinical data of an individual.

According to another feature of the present disclosure, the information providing method may further include a step of predicting a probability for a vascular disease of an individual based on the clinical data and the rendering image.

According to still another feature of the present disclosure, a step of predicting a probability may include a step of extracting features in the rendering image and a step of predicting a probability for a vascular disease of the individual by inputting the clinical data and the feature to the third model trained to predict a probability for the vascular disease of the individual with the clinical data and the feature as inputs.

According to still another feature of the present disclosure, the CTA projection image may be a single imaged projection image after injecting a contrast agent but is not limited thereto.

According to still another feature of the present disclosure, the contrast agent concentration may be ˜ or lower, but is not limited thereto.

According to still another feature of the present disclosure, the first model for every contrast agent concentration is at least one of a first model of a contrast agent concentration of 0%, a first model of a contrast agent concentration of 10%, a first model of a contrast agent concentration of 20%, a first model of a contrast agent concentration of 30%, a first model of a contrast agent concentration of 40%, a first model of a contrast agent concentration of 50%, a first model of a contrast agent concentration of 60%, a first model of a contrast agent concentration of 70%, a first model of a contrast agent concentration of 80%, a first model of a contrast agent concentration of 90%, and a first model of a contrast agent concentration of 100%, but is not limited thereto.

According to still another feature of the present disclosure, prior to the selecting step, the information providing method may further include: a step of generating a second extraction image for a blood vessel from a received CTA projection image; a step of acquiring a thickness of a blood vessel from the second extraction image; a step of generating a third extraction image at every contrast agent concentration from the second extraction image by converting an image intensity of the second extraction image based on the blood vessel thickness; a step of generating a simulation image for at least one or more contrast agent concentrations, by applying the third extraction image at every contrast agent concentration to computer simulation for the CTA system; a step of generating a first dataset at every contrast agent concentration by matching the received CTA projection image to each simulation image at every contrast agent concentration; and a step of training the first model at every contrast agent concentration based on the first dataset at every contrast agent concentration.

According to still another feature of the present disclosure, the step of generating a second extraction image may include a step of applying a threshold value after removing data for a bone in the received CTA projection image.

According to still another feature of the present disclosure, the step of acquiring a blood vessel thickness may include a step of measuring a blood vessel thickness in the second extraction image in one or more side directions, and a step of calculating an average value for one or more measured blood vessel thicknesses.

According to still another feature of the present disclosure, the step of generating a third extraction image may include a step of selecting at least one or more of predetermined blood vessel transformation formulas at every blood vessel thickness based on the blood vessel thickness and a step of generating a third extraction image at every contrast agent concentration from the second extraction image by applying at least one selected transformation formula to the second extraction image.

According to still another feature of the present disclosure, the predetermined transformation formula at every blood vessel thickness may be calculated based on a CTA projection image for a calibration phantom but is not limited thereto.

According to still another feature of the present disclosure, the third projection image may be an image in which the received CTA projection image is registered to the third extraction image at every concentration but is not limited thereto.

According to still another feature of the present disclosure, the step of generating a rendering image may be based on at least one of filtered back-projection (FBP), algebraic reconstruction technique (ART), maximum likelihood expectation maximization (ML-EM), and automap, but is not limited thereto.

According to still another feature of the present disclosure, the step of generating a rendering image may include a step of generating a rendering image for the blood vessel by inputting the first extraction image to a second model which is trained to generate a rendering image with the first extraction image as an input.

According to still another feature of the present disclosure, the step of generating a rendering image may further include a step of correcting the image quality of a rendering image.

According to still another feature of the present disclosure, the correction may include at least one of restoration, enhancement, registration, and linear correction, but is not limited thereto.

In order to achieve another object as described above, the present disclosure provides an information providing device for angiography including: a communication unit which is configured to receive a computed tomography angiography (CTA) projection image of an individual and CTA contrast agent concentration data; and a processor communicably connected to the communication unit, in which the processor is further configured to select one of first models at every contrast agent concentration trained to generate a first extraction image for a blood vessel with a projection image for CTA as an input based on the contrast agent concentration data, generate a first extraction image by inputting the received projection image to the selected first model, and generate a rendering image from the first extraction image.

According to a feature of the present disclosure, the communication unit may be further configured to receive clinical data of the individual.

According to another feature of the present disclosure, the processor may be further configured to predict a probability for a vascular disease of an individual based on the clinical data and the rendering image.

According to still another feature of the present disclosure, the processor may be configured to extract features in the rendering image and predict a probability for a vascular disease of the individual by inputting the clinical data and the feature to the third model trained to predict a probability for the vascular disease of the individual with the clinical data and the feature as inputs.

According to still another feature of the present disclosure, the CTA projection image may be a single imaged projection image after injecting a contrast agent but is not limited thereto.

According to still another feature of the present disclosure, the contrast agent concentration may be ˜ or lower, but is not limited thereto.

According to still another feature of the present disclosure, the first model for every contrast agent concentration may be at least one of a first model of a contrast agent concentration of 0%, a first model of a contrast agent concentration of 10%, a first model of a contrast agent concentration of 20%, a first model of a contrast agent concentration of 30%, a first model of a contrast agent concentration of 40%, a first model of a contrast agent concentration of 50%, a first model of a contrast agent concentration of 60%, a first model of a contrast agent concentration of 70%, a first model of a contrast agent concentration of 80%, a first model of a contrast agent concentration of 90%, and a first model of a contrast agent concentration of 100%, but is not limited thereto.

According to still another feature of the present disclosure, the processor may be further configured to, prior to selecting one of the first models at every contrast agent concentration, generate a second extraction image for a blood vessel from a received CTA projection image, acquire a thickness of a blood vessel from the second extraction image, generate a third extraction image at every contrast agent concentration from the second extraction image by converting an image intensity of the second extraction image based on the blood vessel thickness, generate a simulation image for at least one or more contrast agent concentrations, by applying the third extraction image at every contrast agent concentration to computer simulation for the CTA system, generate a first dataset at every contrast agent concentration by matching the received CTA projection image to each simulation image at every contrast agent concentration, and train the first model at every contrast agent concentration based on the first dataset at every contrast agent concentration.

According to still another feature of the present disclosure, the processor may include a step of applying a threshold value after removing data for a bone in the received CTA projection image.

According to still another feature of the present disclosure, the processor may be configured to measure a blood vessel thickness in the second extraction image in one or more side directions and calculate an average value for one or more measured blood vessel thicknesses.

According to still another feature of the present disclosure, the processor may be configured to select at least one or more of predetermined blood vessel transformation formulas at every blood vessel thickness based on the blood vessel thickness and generate a third extraction image at every contrast agent concentration from the second extraction image by applying at least one selected transformation formula to the second extraction image.

According to still another feature of the present disclosure, the predetermined transformation formula at every blood vessel thickness may be calculated based on a CTA projection image for a calibration phantom but is not limited thereto.

According to still another feature of the present disclosure, the third projection image may be an image in which the received CTA projection image is registered to the third extraction image at every concentration but is not limited thereto.

According to still another feature of the present disclosure, the processor may be based on at least one of filtered back-projection (FBP), algebraic reconstruction technique (ART), maximum likelihood expectation maximization (ML-EM), and automap, but is not limited thereto.

According to still another feature of the present disclosure, the processor may be configured to generate a rendering image for the blood vessel by inputting the first extraction image to a second model which is trained to generate a rendering image with the first extraction image as an input.

According to still another feature of the present disclosure, the processor may be further configured to correct the image quality of the rendering image.

According to still another feature of the present disclosure, the correction may include at least one of restoration, enhancement, registration, and linear correction, but is not limited thereto.

In order to achieve the above-described objects, the present disclosure provides an information providing method for angiography which is implemented by a processor including: a step of receiving a projection image of a computed tomography angiography (CTA) of an individual; a step of generating a first extraction image for a blood vessel by inputting the received CTA projection image to a first model which is trained to generate a first extraction image for the blood vessel with a CTA projection image as an input; and a step of generating a rendering image from the first extraction image.

According to a feature of the present disclosure, the CTA projection image may be a single imaged projection image after injecting a contrast agent but is not limited thereto.

According to another feature of the present disclosure, prior to the step of generating a first extraction image, the method may further include a step of extracting blood vessel data from the received CTA projection image; a step of generating at least one or more first simulation images for the blood vessel data by applying the blood vessel data to a computer simulation for the CTA system; and a step of training a first model based on the received CTA projection image and the first simulation image.

According to still another feature of the present disclosure, the extracted blood vessel data may be a 3D image but is not limited thereto.

According to still another feature of the present disclosure, the extracting step may include a step of applying a threshold value after removing data for a bone in the received CTA projection image.

According to still another feature of the present disclosure, the step of generating a first simulation image may further include a step of generating the first simulation image as 2D data, a step of converting the 2D data into a binary image, and a step of generating an extraction map from the binary image.

According to still another feature of the present disclosure, the step of training a first model may further include: a step of training the first model based on the received CTA projection image and the extraction map.

According to still another feature of the present disclosure, prior to the step of generating a first extraction image, the information providing method may further include a step of extracting medical procedure data from the received CTA projection image; a step of generating at least one or more second simulation images for the medical procedure data by applying the medical procedure data to a computer simulation for the CTA system; and a step of training a first model based on the received CTA projection image and the second simulation image.

According to still another feature of the present disclosure, the step of generating a first extraction image may further include a step of generating a second extraction image for medical procedure data by inputting the received CTA projection image to the first model which is trained to generate the second extraction image for the medical procedure data with the CTA projection image as an input.

According to still another feature of the present disclosure, the step of generating a rendering image may further include a step of generating a rendering image from the first extraction image and the second extraction image.

According to still another feature of the present disclosure, the step of generating a rendering image may further include a step of generating a first rendering image and a second rendering image by inputting the first extraction image and the second extraction image to a second model trained to generate rendering images with the first extraction image and the second extraction image as inputs; and a step of registering the generated first rendering image and second rendering image.

According to still another feature of the present disclosure, the step of generating a rendering image may be based on at least one of filtered back-projection (FBP), algebraic reconstruction technique (ART), maximum likelihood expectation maximization (ML-EM), and automap, but is not limited thereto.

According to still another feature of the present disclosure, the step of generating a rendering image may include a step of generating a rendering image for the blood vessel by inputting the first extraction image to a second model which is trained to generate a rendering image with the first extraction image as an input.

According to still another feature of the present disclosure, the step of generating a rendering image may further include a step of correcting an image quality of a rendering image.

According to still another feature of the present disclosure, the correction may include at least one of restoration, enhancement, registration, and linear correction.

According to still another feature of the present disclosure, the information providing method may further include the step of receiving clinical data of an individual.

According to still another feature of the present disclosure, the information providing method may further include a step of predicting a probability for a vascular disease of an individual based on the clinical data and the rendering image.

According to still another feature of the present disclosure, the step of predicting a probability may include a step of extracting features in the rendering image and a step of predicting a probability for a vascular disease of the individual by inputting the clinical data and the feature to the third model trained to predict a probability for the vascular disease of the individual with the clinical data and the feature as inputs.

In order to achieve another object as described above, the present disclosure provides an information providing device including: a communication unit configured to receive a projection image of a computed tomography angiography (CTA) of an individual; and a processor communicably connected to the communication unit, in which the processor is configured to generate a first extraction image for a blood vessel by inputting the received CTA projection image to a first model which is trained to generate a first extraction image for the blood vessel with a CTA projection image as an input and generate a rendering image from the first extraction image.

According to a feature of the present disclosure, the CTA projection image may be a single imaged projection image after injecting a contrast agent but is not limited thereto.

According to another feature of the present disclosure, the processor may be further configured to, prior to generating the first extraction image, extract blood vessel data from the received CTA projection image, generate at least one or more first simulation images for the blood vessel data by applying the blood vessel data to a computer simulation for the CTA system; and train a first model based on the received CTA projection image and the first simulation image.

According to still another feature of the present disclosure, the extracted blood vessel data may be a 3D image but is not limited thereto.

According to still another feature of the present disclosure, the processor may be configured to apply a threshold value after removing data for a bone in the received CTA projection image.

According to still another feature of the present disclosure, the processor may be further configured to generate the first simulation image as 2D data, convert the 2D data into a binary image, and generate an extraction map from the binary image.

According to still another feature of the present disclosure, the processor may be further configured to train the first model based on the received CTA projection image and the extraction map.

According to still another feature of the present disclosure, the processor may be further configured to, prior to generating the first extraction image, extract medical procedure data from the received CTA projection image, generate at least one or more second simulation images for the medical procedure data by applying the medical procedure data to a computer simulation for the CTA system, and train a first model based on the received CTA projection image and the second simulation image.

According to still another feature of the present disclosure, the processor may be further configured to generate a second extraction image for medical procedure data by inputting the received CTA projection image to the first model which is trained to generate the second extraction image for the medical procedure data with the CTA projection image as an input.

According to still another feature of the present disclosure, the processor may be further configured to generate a rendering image from the first extraction image and the second extraction image.

According to still another feature of the present disclosure, the processor may be configured to generate a first rendering image and a second rendering image by inputting the first extraction image and the second extraction image to a second model trained to generate rendering images with the first extraction image and the second extraction image as inputs and register the generated first rendering image and second rendering image.

According to still another feature of the present disclosure, the rendering image is generated based on at least one of filtered back-projection (FBP), algebraic reconstruction technique (ART), maximum likelihood expectation maximization (ML-EM), and automap, but is not limited thereto.

According to still another feature of the present disclosure, the processor may be configured to generate a rendering image for the blood vessel by inputting the first extraction image to a second model which is trained to generate a rendering image with the first extraction image as an input.

According to still another feature of the present disclosure, the processor may be further configured to correct the image quality of the rendering image.

According to still another feature of the present disclosure, the correction may include at least one of restoration, enhancement, registration, and linear correction, but is not limited thereto.

According to still another feature of the present disclosure, the communication unit may be further configured to receive clinical data of an individual.

According to still another feature of the present disclosure, the processor may be further configured to predict a probability for a vascular disease of an individual based on the clinical data and the rendering image.

According to still another feature of the present disclosure, the processor may be configured to extract features in the rendering image and predict a probability for a vascular disease of the individual by inputting the clinical data and the feature to the third model trained to predict a probability for the vascular disease of the individual with the clinical data and the feature as inputs.

Hereinafter, the present disclosure will be described in detail with reference to the exemplary embodiments. However, the exemplary embodiments are only for illustrative purposes of the present disclosure, and therefore the scope of the present disclosure should not be construed as being limited by these exemplary embodiments.

According to the present disclosure, a 3D rendering image with a high accuracy may be provided with a CTA projection image imaged based on a low-concentration contrast agent and a vascular disease of an individual may be predicted based on this.

Therefore, according to the present disclosure, a side-effect due to the contrast agent may be minimized.

Moreover, according to the present disclosure, various machine learning training data according to the concentration of the contrast agent is generated based on a calibration phantom and computer simulation so that data which was difficult to be obtained due to ethics and personal information issues may be more easily constructed to be used to train the machine learning, thereby improving the accuracy and the reliability of the machine learning.

Further, the model of the present disclosure is trained based on various data so that the high density medical procedure data loss due to the noise according to the movement of the artifact and beam hardening which are the limitations of the related art is corrected even with the projection image which is single imaged in the CTA equipment is corrected to generate a 3D image, thereby solving the problem of the double covering (over-covering).

For example, in the CTA methods of the related art, even though the blood vessel data is extracted, a process of removing bone and high density information having a similar Hounsfield unit (HU) value by a medical staff or a medical engineer needs to be included. However, according to the present disclosure, this process is omitted and the blood vessel and high density of medical procedure data are automatically and accurately extracted by the machine learning and the 3D rendering image is generated based on this, thereby maximizing the efficiency of generating an image.

Further, according to the present disclosure, the highly accurate prediction of the vascular disease may also be provided based on the 3D rendering image with high accuracy and precision generated by the above-described process to assist the medical staff to quickly determine the diagnosis.

According to the present disclosure, a 3D rendering image with a high accuracy may be provided with a single-imaged CTA projection image and a vascular disease of an individual may be predicted based on this.

To be more specific, according to the present disclosure, blood vessel and high-density medical procedure data are directly extracted from the CTA projection image and the computer simulation modeling is performed based on this to generate various images with a small number of data and train the model and improve the accuracy based on this.

Further, the model of the present disclosure is trained based on various data so that the high density medical procedure data loss due to the noise according to the movement of the artifact and beam hardening which are the limitations of the related art is corrected even with the projection image which is single-imaged in the CTA equipment to generate a 3D image, thereby solving the problem of the double covering (over-covering).

For example, in the CTA methods of the related art, even though the blood vessel data is extracted, a process of removing the bone and high-density information having a similar Hounsfield unit (HU) value by a medical staff or a medical engineer needs to be included.

However, according to the present disclosure, this process is omitted and the blood vessel and high-density medical procedure data are automatically and accurately extracted and the 3D rendering image is generated based on this, thereby maximizing the efficiency of generating an image.

Further, according to the present disclosure, the highly accurate prediction of the vascular disease may also be provided based on the 3D rendering image with high accuracy and precision generated by the above-described process to assist the medical staff to quickly determine the diagnosis.

The effects according to the present disclosure are not limited to the contents exemplified above, and more various effects are included in the present specification.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1A exemplarily illustrates a system based on an information providing method for an angiography according to an exemplary embodiment of the present disclosure;

FIG. 1B is a block diagram illustrating a configuration of an information providing device for an angiography according to an exemplary embodiment of the present disclosure;

FIG. 1C is a block diagram illustrating a configuration of a medical staff device according to an exemplary embodiment of the present disclosure;

FIG. 1D is a schematic view of user interfaces of a medical staff device and a medical imaging device according to an exemplary embodiment of the present disclosure;

FIG. 2 is a flowchart for an information providing method for an angiography according to an exemplary embodiment of the present disclosure.

FIG. 3 is a schematic view for an information providing method for an angiography according to an exemplary embodiment of the present disclosure;

FIG. 4 is a schematic view for model training data in an information providing method for an angiography according to an exemplary embodiment of the present disclosure;

FIG. 5 is a schematic view for rendering image generation in an information providing method for an angiography according to an exemplary embodiment of the present disclosure;

FIG. 6 is a flowchart for an information providing method for an angiography to reduce a contrast agent according to another exemplary embodiment of the present disclosure;

FIG. 7 is a schematic view for an information providing method for an angiography to reduce a contrast agent according to another exemplary embodiment of the present disclosure;

FIG. 8 is a schematic view for a learning process of a first model in an information providing method for an angiography to reduce a contrast agent according to another exemplary embodiment of the present disclosure;

FIG. 9 is a schematic view for a calibration phantom and a transformation formula thereof used in an information providing method for an angiography to reduce a contrast agent according to another exemplary embodiment of the present disclosure; and

FIG. 10 is a schematic view for prediction of a vascular disease in an information providing method for angiography according to another exemplary embodiment of the present disclosure.

### DETAILED DESCRIPTION

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Advantages and characteristics of the present disclosure and a method of achieving the advantages and characteristics will be clear by referring to exemplary embodiments described below in detail together with the accompanying drawings. However, the present disclosure is not limited to the following exemplary embodiments but may be implemented in various different forms. The exemplary embodiments are provided only to complete the disclosure of the present disclosure and to fully provide a person having ordinary skill in the art to which the present disclosure pertains with the category of the disclosure.

The term “or” as used in the present specification means “and/or” unless otherwise stated.

The term “approximate (approximately)” as used herein refers to the normal error range for each value that is readily known to those skilled in the art. The “approximate” value or a parameter referred in this specification includes exemplary embodiments relating to that value or parameter itself. Moreover, the term “approximate” indicates a range of values within 10% in any one direction (larger than or less than) of a mentioned reference value unless otherwise mentioned or clear from the contest.

The term “patient or individual” used in the present specification is interchangeably used and refers to any single animal, and more desirably a mammal (including non-human animals, such as cats, dogs, horses, rabbits, zoo animals, cows, pigs, sheep, and non-human primates) for which treatment is required. A patient referred in various exemplary embodiments of the present disclosure may be human.

System based on information providing method for angiography according to exemplary embodiment of present disclosure

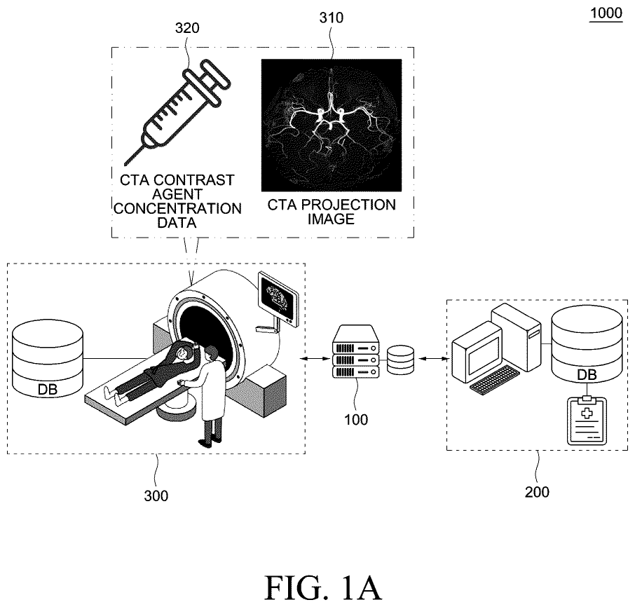

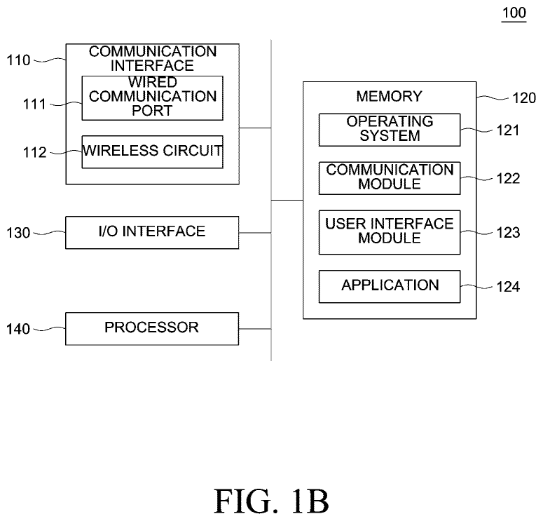

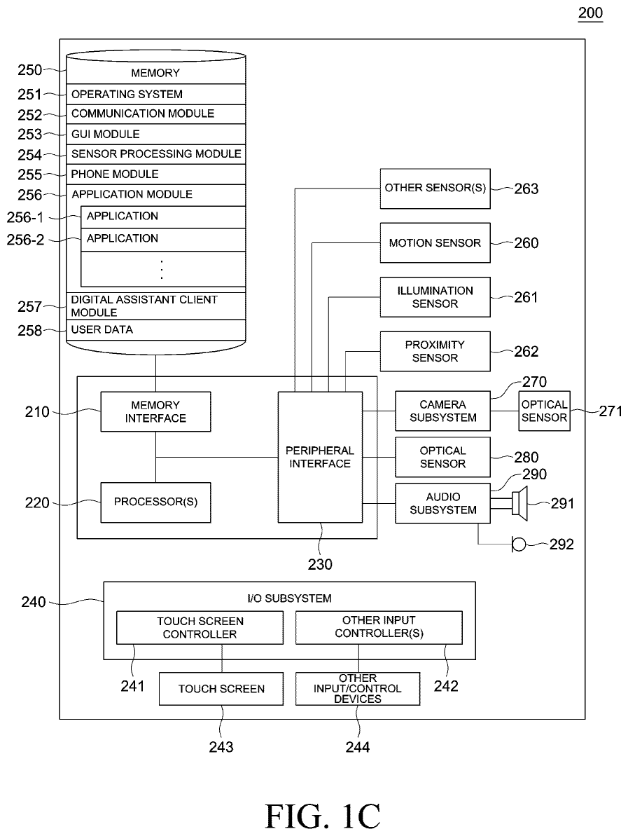

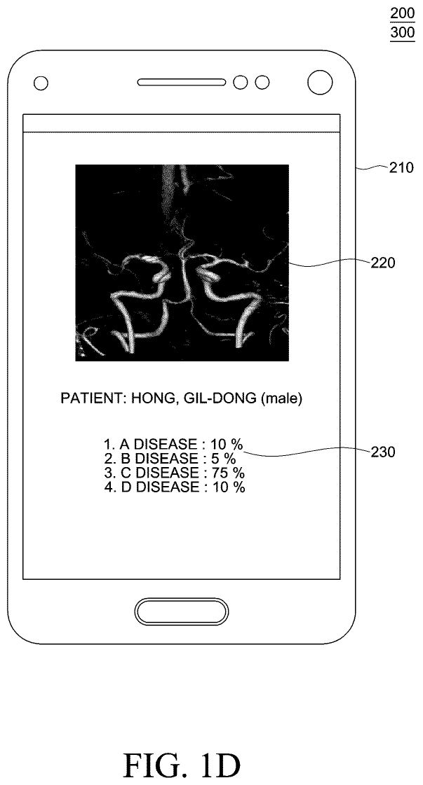

FIG. 1A exemplarily illustrates a system based on an information providing method for an angiography according to an exemplary embodiment of the present disclosure.

First, referring to FIG. 1A, the information providing system 1000 for angiography may be a system which is configured to provide information related to computed tomography angiography (CTA) of an individual based on various data collected from the individual.

At this time, the information providing system 1000 for angiography may be configured by an information providing device 100 for angiography configured to generate a rendering image of a projection image based on data collected from the individual, that is, clinical data and CTA projection images and predict a vascular disease of an individual based on the generated rendering image and the above-described clinical data, a medical staff device 200 which transmits and receives information about the angiography, and a computed tomographic device (medical imaging device) 300.

At this time, the information providing device 100 for angiography, the medical staff device 200, and the medical imaging device 300 may transmit and receive various information via wired/wireless communication.

To be more specific, the information providing device 100 for angiography, the medical staff device 200, and the medical imaging device 300 may be directly connected with cables to perform wired communication or, desirably, perform wireless communication by omitting the cables.

Therefore, the information providing device 100 for angiography, the medical staff device 200, and the medical imaging device 300 may be connected to a network for wireless communication and the network may be a closed network such as a local area network (LAN) or a wide area network (WAN), an open network such as Internet, and a short range wireless communication, such as Bluetooth, near field communication (NFC), radio-frequency identification (RFID), Wi-Fi, or Zigbee, but are not limited thereto.

The information providing device 100 for angiography according to the exemplary embodiment of the present disclosure may include a general purpose computer, a laptop, and/or a data server which generates medical image data of an individual collected from the medical staff device 200 and/or the medical imaging device 300, that is, computed tomography angiography (CTA) projection image and a rendering image (3D image) for a blood vessel based on clinical data, and performs various computations for predicting a vascular disease of an individual.

To be more specific, referring to FIG. 1B, a block diagram illustrating a configuration of an information providing device for an angiography according to an exemplary embodiment of the present disclosure is illustrated. The information providing device 100 for angiography may include a communication interface 110, a memory 120, an I/O interface 130, and a processor 140 and each configuration may communicate with each other via one or more communication buses or signal lines.

The communication interface 110 may refer to a communication unit 110 and may be connected to the medical staff device 200 and the medical imaging device 300 via a wired/wireless communication network to exchange data. For example, the communication interface 110 may receive various data (clinical data and medical image data) for an individual from the medical staff device 200 and/or the medical imaging device 300 in real time. As another example, the communication interface 110 may transmit various medical data and medical images related to the individual to the medical staff device 200.

In the meantime, the communication interface 110 which enables the transmission/reception of the data may include a wired communication port 111 and a wireless circuit 112 and the wired communication port 111 may include one or more wired interfaces, such as Ethernet, universal serial bus (USB), and fire wire. Further, the wireless circuit 112 may transmit and receive data with external devices by an RF signal or an optical signal. In addition, the wireless communication may use at least one of a plurality of communication standards, protocols, and technologies, such as GSM, EDGE, CDMA, TDMA, Bluetooth, Wi-Fi, VOIP, Wi-Max, or other arbitrary appropriate communication protocols.

The memory 120 may store various data which is used for the information providing device 100 for an angiography and derived from the information providing device.

To be more specific, the memory 120 may store a prediction model and also store various data which is extracted or generated (predicted) from the previously described prediction model. For example, the memory 120 may include various algorithms, parameters, functions, and extracted (generated) data included in the model, but is not limited thereto.

Moreover, the memory 120 may include all various data related to the output data. For example, the memory 120 may include various extracted data of a process for generating a rendering image of an individual, but is not limited thereto.

Further, the memory 120 may store various data collected from the medical staff device 200 or the medical imaging device 300, that is, various data such as clinical data and the medical image.

To be more specific, the medical image may include images derived (generated) from a medical imaging device, such as CT, MRI, and X-ray, but is not limited thereto, and may include various medical images which are used to confirm and evaluate diseases of the individuals. Most desirably, the medical image may be a computed tomography angiography (CTA) projection image.

In various exemplary embodiments, the memory 120 may include a volatile or nonvolatile recording medium which may store various data, commands, and information. For example, the memory 120 may include at least one type of storage media of a flash memory type, a hard disk type, a multimedia card micro type, a card type memory (for example, an SD or XD memory), a RAM, an SRAM, a ROM, an EEPROM, a PROM, a network storage, a cloud, and a block chain database.

In various exemplary embodiments, the memory 120 may store at least one configuration of an operating system 121, a communication module 122, a user interface module 123, and one or more applications 124.

The operating system 121 (for example, an embedded operating system, such as LINUX, UNIX, MAC OS, WINDOWS, VxWorks) may include various software components and drivers which control and manage a general system task (for example, memory management, storage device control, or power management) and support communication between various hardware, firmware, and software components.

The communication module 122 may support communication with other devices through the communication interface 110. The communication module 122 may include various software components for processing data received by a wired communication port 110 or a wireless circuit 112 of the communication interface 110.

The user interface module 123 may receive a request or an input of the user from a keyboard, a touch screen, a mouse, or a microphone via the I/O interface 130 and provide the user interface on the display.

The application 124 may include a program or a module configured to be executed by one or more processors 140. Here, the application for providing information about cognitive disorders may be implemented on a server farm.

The I/O interface 130 may connect at least one of input/output devices (not illustrated) of the information providing device 100 for angiography, such as a display, a keyboard, a touch screen, and a microphone, to the user interface module 123. The I/O interface 130 may receive the user input (for example, voice input, keyboard input, or touch input) together with the user interface module 123 and process a command in accordance with the received input.

The processor 140 is connected to the communication interface 110, the memory 120, and the I/O interface 130 to control an overall operation of the information providing device 100 for angiography and may perform various commands to extract data related to the cognitive disorder through the application or the program stored in the memory 120.

The processor 140 may correspond to an arithmetic device such as a central processing unit (CPU) or an application processor (AP). Further, the processor 140 may be implemented as an integrated chip (IC) such as a system of chip (SoC) in which various arithmetic devices are integrated. Alternatively, the processor 140 may include a module for calculating an artificial neural network (AI, machine learning) model, such as a neural processing unit (NPU).

Referring to FIG. 1A again, the information providing device 100 for angiography may receive clinical data and medical image data for an individual from the medical staff device 200 and/or the medical imaging device 300, generate a 3D rendering image from the received data, and predict a vascular disease of the individual to be provided to the medical staff device 200 and/or the medical imaging device 300.

As described above, data provided from the information providing device 100 for angiography is provided to a web page through a web browser installed in the medical staff device 200 and/or the medical imaging device 300 or provided as an application or a program. In various exemplary embodiments, the data may be provided to be included in a platform in a client-server environment.

First, the medical staff device 200 is an electronic device which requests to provide information about angiography of an individual and provides a user interface to indicate information data (image data) related to this and may include at least one of a smart phone, a tablet PC (personal computer), a laptop, and/or a PC.

To be more specific, referring to FIG. 1C, a block diagram of a configuration of a medical staff device according to the exemplary embodiment of the present disclosure will be illustrated. The medical staff device 200 may include a memory interface 10, one or more processors 220, and a peripheral interface 230. Various components in the medical staff device 200 may be connected by one or more communication buses or signal lines.

The memory interface 210 is connected to a memory 250 to transmit various data to the processor 220. Here, the memory 250 may include at least one type of storage media of a flash memory type, a hard disk type, a multimedia card micro type, a card type memory (for example, an SD or XD memory), a RAM, an SRAM, a ROM, an EEPROM, a PROM, a network storage, a cloud, and a block chain database.

In various exemplary embodiments, the memory 250 may store at least one of an operating system 251, a communication module 252, a graphic user interface module (GUI) 253, a sensor processing module 254, a telephone module 255, and an application module 256. Specifically, the operating system 251 may include a command for processing a basic system service and a command for performing hardware tasks. The communication module 252 may communicate with at least one of one or more other devices, computers, and servers. The graphic user interface module (GUI) 253 may process a graphic user interface. The sensor processing module 254 may process sensor-related functions (for example, process a received voice input using one or more microphones 292). The telephone module 255 may process telephone-related functions. The application module 256 may perform various functions of the user application, such as electronic messaging, web browsing, media processing, searching, imaging, or other processing functions.

Further, the medical staff device 200 may store one or more software applications 256-1 and 256-2 related to any one type of service in the memory 250. At this time, the application 256-1 may provide information about a cognitive disorder to the medical staff device 200.

In various exemplary embodiments, the memory 250 may store a digital assistant client module 257 (hereinafter, simply referred to as a DA client module) and accordingly, may store commands for performing a function of the client of the digital assistant and various user data 258 (for example, other data such as user-customized vocabulary data, preference data, a user's electronic address book, a to-do list, or other lists).

In the meantime, the DA client module 257 may acquire voice input, text input, touch input and/or gesture input of the user by means of various user interfaces (for example, I/O sub system 240) equipped in the medical staff device 200.

Further, the DA client module 257 may output audio-visual or tactile data. For example, the DA client module 257 may output data formed of a combination of at least two or more of voice, sound, a notice, a text message, a menu, a graphic, a video, an animation, and a vibration. Further, the DA client module 257 may communicate with a digital assistant server (not illustrated) using a communication sub system 280.

In various exemplary embodiments, the DA client module 257 may collect additional information about the surrounding environment of the medical staff device 200 from various sensors, sub systems, and peripheral devices to configure a context associated with the user input. For example, the DA client module 257 may infer the intention of the user by providing context information to the digital assistant server together with the user input. Here, the context information which may be accompanied by the user input may include sensor information, such as light, ambient noises, ambient temperature, an image of the surrounding environment, and a video. As another example, the context information may include a physical state (for example, a device alignment, a device position, a device temperature, a power level, a speed, an acceleration, a motion pattern, or a cellular signal intensity) of the medical staff device 200. As still another example, the context information may include information related to a software state of the medical staff device 200 (for example, a process which is being executed in the medical staff device 200, installed program, past and present network activities, a background service, an error log, or resource usage).

According to various exemplary embodiments, the memory 250 may include added or deleted commands and further, the medical staff device 200 may also include additional configurations other than the configurations illustrated in FIG. 1C or exclude some configurations.

The processor 220 may control the overall operation of the medical staff device 200 and run an application or a program stored in the memory 250 to perform various commands to implement various data interfaces for the cognitive disorder.

The processor 220 may correspond to an arithmetic device such as a central processing unit (CPU) or an application processor (AP). Further, the processor 120 may be implemented as an integrated chip (IC) such as a system of chip (SoC) in which various arithmetic devices, such as a neural processing unit (NPU), are integrated.

The peripheral interface 230 is connected to various sensors, sub systems, and peripheral devices to provide data to allow the medical staff device 200 to perform various functions. Here, when the medical staff device 200 performs any function, it is understood that the function is performed by the processor 220.

The peripheral interface 230 may receive data from a motion sensor 260, an illumination sensor (a light sensor) 261, and a proximity sensor 262 and by doing this, the medical staff device 200 may perform alignment, light, and proximity sensing functions. As another example, the peripheral interface 230 may be provided with data from other sensors 263 (a positioning system-GPS receiver, a temperature sensor, or a biometric sensor) and by doing this, the medical staff device 200 may perform functions related to the other sensors 263.

In various exemplary embodiments, the medical staff device 200 may include a camera sub system 270 connected to the peripheral interface 230 and an optical sensor 271 connected thereto and by doing this, the medical staff device 200 may perform various photographing functions such as taking a picture or recording a video clip.

In various exemplary embodiments, the medical staff device 200 may include a communication sub system 280 connected to the peripheral interface 230. The communication sub system 280 is configured by one or more wired/wireless networks and may include various communication ports, a wireless frequency transceiver, and an optical transceiver.

In various exemplary embodiments, the medical staff device 200 includes an audio sub system 290 connected to the peripheral interface 230 and the audio sub system 290 includes one or more speakers 291 and one or more microphones 292 so that the medical staff device 200 may perform voice-operated functions, such as voice recognition, voice duplication, digital recording, and telephone functions.

In various exemplary embodiments, the medical staff device 200 may include an I/O sub system 240 connected to the peripheral interface 230. For example, the I/O sub system 240 may control the touch screen 243 included in the medical staff device 200 by means of a touch screen controller 241. For example, the touch screen controller 241 may use any one of a plurality of touch sensing techniques such as a capacitive type, a resistive type, an infrared type, a surface acoustic wave technology, or a proximity sensor array to detect contact and movement of the user or stopping of contact and movement. As another example, the I/O sub system 240 may control the other input/control device 244 included in the medical staff device 200 by means of other input controller(s) 242. As an example, other input controller(s) 242 may control one or more buttons, rocker switches, thumb-wheels, infrared ports, USB ports, and pointer devices such as a stylus.

Referring to FIG. 1A again, as a result, the medical staff device 200 includes the configurations as described above to be provided with an image for a blood vessel generated from the information providing device 100 for angiography and prediction data for the vascular disease derived based on this.

The medical imaging device 300 may refer to medical imaging equipment, such as radiography, magnetic resonance imaging (MRI), ultrasound, endoscopy, thermography, and nuclear medicine imaging, and desirably, refer to computed tomography (CT) equipment. To be more specific, the medical imaging device 300 may mean a CT device which collects transmitted X-rays using a detector by radiating a target part of a human body in various directions using X-rays and computers and reconstructs an absorption difference of X-rays of the part as an image using a mathematical technique with a computer.

Moreover, the medical imaging device 300 may be a device which provides the imaged medical image to the information providing device 100 for angiography, displays the medical image on the medical imaging device 300, or adjusts the medical image. As described above, the medical imaging device 300 may include a smart phone, a tablet personal computer (PC), a laptop, and/or a PC, but is not limited thereto and may further include a general purpose computer and/or a data server which provides data for an individual. Moreover, the medical imaging device 300 may include a DB which stores an imaged medical image.

In the meantime, the medical imaging device 300 may include the same configuration as the medical staff device 200 described in FIG. 1C above to display the image and related data. Therefore, the medical imaging device 300 may include an interface which allows a user to directly input and provide clinical data for the individual, data related to the medical image, and data related to a vascular disease of the individual, from a keyboard, a touch screen, a mouse, and a microphone and by doing this, receives data related to the blood vessel of the individual from the user to provide the data to the information providing device 100 for angiography and/or the medical staff device 200.

With regard to this, referring to FIG. 1D, a schematic view of user interfaces of a medical staff device and a medical imaging device according to an exemplary embodiment of the present disclosure is illustrated.

Referring to FIG. 1D, the medical staff device 200 and the medical imaging device 300 used for the information providing system for angiography according to an exemplary embodiment of the present disclosure are provided with various data which is generated and derived from the information providing device 100 for angiography. Therefore, the medical staff device 200 and the medical imaging device 300 may display the provided data on the interface.

To be more specific, the medical staff device 200 and the medical imaging device 300 may be configured to display a rendering image 220 generated from the information providing device 100 for angiography and prediction data 230 for the vascular disease predicted from the information providing device 100 for angiography on the user interface screen (UI) 210.

Moreover, not only the above-described rendering image 220 and prediction data 230, but also various data used for the information providing device 100 for angiography may be displayed on the user interface screen 210. For example, all the blood vessel extraction image generated from the information providing device 100 for angiography and various clinical data related to the individual may be displayed on the user interface screen 210 but are not limited thereto.

Therefore, the medical staff device 200 and the medical imaging device 300 may more easily acquire and identify various data generated and predicted from the information providing device 100 for angiography.

As a result, the medical staff device 200 and the medical imaging device 300 receive various data generated and predicted from the information providing device 100 for angiography through the user interface screen 210 and received data may be displayed through the user interface screen 210 to be provided to the user.

Referring to FIG. 1A again, various medical image data imaged (derived) by the medical imaging device 300 may be provided not only to the information providing device 100 for angiography but also to the medical staff device 200. For example, not only the projection image imaged by the medical imaging device 300, but also raw data stored in the medical imaging device 300 with regard to this is transmitted to the information providing device 100 for angiography and the medical staff device 200 to be used but is not limited thereto.

As a result, the information providing system for angiography based on the information providing device for angiography according to the exemplary embodiment of the present disclosure includes the information providing device 100 for angiography, the medical staff device 200, and the medical imaging device 300 so that a medical image is received from the medical imaging device 300, at the same time, clinical data is received from the medical staff device 200, and rendering images associated with the blood vessels of the individuals are generated based on the data received from the information providing device 100 for angiography. Moreover, various information (data) associated with the vascular disease of the individual is predicted and determined and various information (data) derived from the information providing device 100 for angiography may be provided to the medical staff device 200 and/or the medical imaging device 300. However, the present disclosure is not limited thereto, and an operation of predicting and determining a vascular disease for an individual based on the received data may be performed by the medical staff device 200.

Information providing method for angiography according to various exemplary embodiment of present disclosure

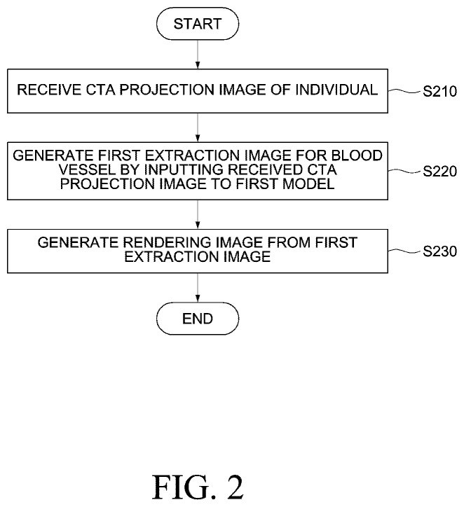

Hereinafter, a process for an information providing method for angiography according to an exemplary embodiment of the present disclosure will be described with reference to FIGS. 2 to 10.

First, FIG. 2 is a flowchart for an information providing method for an angiography according to an exemplary embodiment of the present disclosure.

Referring to FIG. 2, an information providing method for angiography according to an exemplary embodiment of the present disclosure is an information providing method for angiography which is performed by a processor and may include a step S210 of receiving a projection image of a computed tomography angiography (CTA) of an individual, a step S220 of generating a first extraction image for a blood vessel with a CTA projection image received to a first model as an input, and a step S230 of generating a rendering image from the first extraction image.

Further, in the step S210 of receiving the CTA projection image, the CTA projection image may refer to a 2D projection image obtained by imaging an X-ray-based CTA but is not limited thereto and may include all various medical images from which the blood vessel can be extracted. Moreover, the CTA projection image may refer to a projection image single-imaged after injecting a contrast agent. Generally, an imaging technique based on the CTA projection image of the related art is performed based on two CT images acquired by secondary imaging, after injecting the contrast agent, which causes double covering due to the secondary imaging. Moreover, according to the method of the related art, during the secondary imaging time, if the individual moves, it may cause an artifact. However, when the contract agent according to the exemplary embodiment of the present disclosure shows maximum contrast enhancement in the region of interest, the single imaging is performed to generate a 3D blood vessel image (3D rendering image) including accurate blood vessel information.

Next, the first model in the step S220 of generating a first extraction image may be a model trained to generate a first extraction image for a blood vessel with a CTA projection image as an input. Therefore, the information providing method for angiography according to an exemplary embodiment of the present disclosure may include a training step to train the first model, prior to the generating step S220.

To be more specific, the first model may be trained based on a first simulation image for the blood vessel data and a second simulation image for medical procedure data. At this time, the medical procedure data may refer to data related to a high-density material (tool) used for a blood vessel-related disease, and for example, may include medical procedure data, such as stent included in the blood vessel or around the blood vessel, but is not limited thereto.

First, with regard to the first simulation image for the blood vessel data, the information providing method for angiography according to an exemplary embodiment of the present disclosure, prior to the step of generating a first extraction image, may include a step of extracting blood vessel data from the received CTA projection image, a step of generating at least one or more first simulation images for the blood vessel data by applying the blood vessel data to the computer simulation for the CTA system, and a step of training the first model based on the received CTA projection image and the first simulation image. At this time, the extracted blood vessel data may refer to a 3D image but is not limited thereto and include all data related to the blood vessel extracted from the CTA projection image.

The step of extracting blood vessel data may include the step of applying a threshold value after removing data for a bone in the received CTA projection image. To be more specific, when the received CTA projection image is an image derived from a dual energy CT, information about a bone having an image intensity similar to that of the contrast agent may not be completely removed and the medical procedure information about the high-density material, such as metal may be lost due to beam hardening. Therefore, as described above, the present disclosure may include a step of extracting the medical procedure information about the high-density material, such as a metal material by removing the bone and applying a threshold value. Accordingly, the present disclosure includes a step of applying the threshold value after removing data about the bone in the received CTA projection image described above, so that various CTA projection images may be used without being restricted by the CT imaging method.

The step of generating a first simulation image may further include a step of generating the first simulation image as 2D data, a step of converting the 2D data into a binary image, and a step of generating an extraction map from the binary image.

At this time, the computer simulation refers to a simulation which implements the same environment (an irradiator, a detector, and an irradiation condition) as the actual medical imaging system and may generate 2D data, that is, a virtual projection image based on the extracted blood vessel data. Moreover, the 2D data may be converted into a binary image, that is, an image configured by two values, such as black and white or 0 and 1 to more clearly distinguish a target. Therefore, according to the present disclosure, the target may be more clearly distinguished and extracted to be generated as an extraction map.

Moreover, as the present disclosure includes a step of generating an extraction map as described above, a step of training a first model based on the received CTA projection image and the extraction map may be further included.

Next, with regard to the second simulation image for the medical procedure data, the information providing method for angiography according to an exemplary embodiment of the present disclosure, prior to the step of generating a first extraction image, may include a step of extracting medical procedure data from the received CTA projection image, a step of generating at least one or more second simulation images for the medical procedure data by applying the medical procedure data to the computer simulation for the CTA system, and a step of training the first model based on the received CTA projection image and the second simulation image.

At this time, the step of training the first model based on the second simulation image may include the same step as the step of learning based on the first simulation image described above. That is, only data extracted from the received CTA projection image is different, but the process of deriving the subsequent simulation image may be the same.

Therefore, the step of generating the second simulation image of the present disclosure may also further include a step of generating 3D data, converting 2D data into a binary image, and generating an extraction map from the binary image. Therefore, the step of training the first model may also further include a step of training the first model based on the CTA projection image and the extraction map.

As a result, the present disclosure includes steps prior to the above-described step of generating a first extraction image so that a plurality of data for training the first model may be easily acquired to allow the first model to be trained based on this to have high accuracy and reliability.

Moreover, the first model of the present disclosure is trained based on not only the blood vessel data, but also the second simulation image related to the medical procedure data so that the first model may generate not only the first extraction image for the blood vessel, but also the second extraction image for the medical procedure data.

Therefore, the first model in the step S220 of generating a first extraction image may be a model trained to generate a second extraction image for medical procedure data with a CTA projection image as an input. Moreover, the step S220 of generating a first extraction image may further include a step of generating a second extraction image for medical procedure data by inputting the received CTA projection image to the first model which is trained to generate the second extraction image for the medical procedure data with the CTA projection image as an input.

In the step S230 of generating a rendering image, the rendering image may refer to a 3D graphic image having a three-dimensional effect derived by assigning shadow, color, and density in consideration of data, such as a shape, a position, and illumination of 2D data (image).

The step S230 of generating a rendering image may be based on at least one of filtered back-projection (FBP), algebraic reconstruction technique (ART), maximum likelihood expectation maximization (ML-EM), and an automap, but is not limited thereto and may include all various methods which convert a 2D image into a 3D image.

However, desirably, the step S230 of generating a rendering image of the present disclosure may be a step based on the machine learning method.

Therefore, the step S230 of generating a rendering image may include a step of generating a rendering image for a blood vessel by inputting the first extraction image to the second learning model. At this time, the second learning model may be a model trained to generate a rendering image with the first extraction image as an input but is not limited thereto.

Moreover, the present disclosure includes not only the first extraction image for a blood vessel, but also the second extraction image for medical procedure data and the second extraction image may also be used to generate a rendering image. Therefore, the step S230 of generating a rendering image may further include a step of generating a rendering image from the first extraction image and the second extraction image.

Moreover, the step S230 of generating a rendering image may include a step of generating a first rendering image and a second rendering image by inputting the first extraction image and the second extraction image to the second learning model and a step of registering the generated first rendering image and second rendering image. At this time, the second learning model may be a model trained to generate a rendering image with the first extraction image and the second extraction image as inputs but is not limited thereto.

Data loss or errors may be generated while converting the rendering image so that the step S230 of generating a rendering image may further include a step of correcting the loss or error. That is, the step S230 of generating a rendering image may further include a step of correcting an image quality of a rendering image and at this time, the correction may include at least one of restoration, enhancement, registration, and linear correction, but is not limited thereto.

By these processes as described above, the information providing method for angiography according to an exemplary embodiment of the present disclosure may generate a blood vessel rendering image with a high quality based on the single-imaged CTA image.

Moreover, according to the present disclosure, blood vessel procedure information (data) based on a high-density material which is difficult to be reflected to the 3D image due to the beam hardening in the related art is extracted by a separate process from the blood vessel data and corrected to be more accurately displayed on the rendering image.

Further, according to the present disclosure, medical image data and clinical data that are difficult to obtain due to many regulations and restrictions such as personal information protection may be easily obtained in various cases through the computer simulation. Therefore, according to the present disclosure, the machine learning model is trained with a plurality of data obtained by the above-described computer simulation so that the machine learning model of the present disclosure may derive a result with a high reliability and accuracy.

In the meantime, the information providing method for angiography according to the exemplary embodiment of the present disclosure may predict and provide not only a rendering image, but also a vascular disease of an individual based on the rendering image.

Therefore, the information providing method for angiography according to various exemplary embodiment of present disclosure may further include a step of receiving clinical data of an individual and further include a step of predicting a probability for a vascular disease of an individual based on the clinical data and the rendering image. At this time, the clinical data may refer to data including various examination results, prescription data, treatment records, and personal information about an individual stored within a medical institution.

To be more specific, a step of predicting a probability may include a step of extracting features in the rendering image and a step of predicting a probability for a vascular disease of an individual by inputting clinical data and features to a third model. At this time, the third model may be a model trained to predict a probability for a vascular disease of an individual with clinical data and features as inputs but is not limited thereto.

As a result, according to the present disclosure, a high-quality rendering image is generated and provided and prediction information for a vascular disease of an individual with a high accuracy and reliability may be provided based on this.

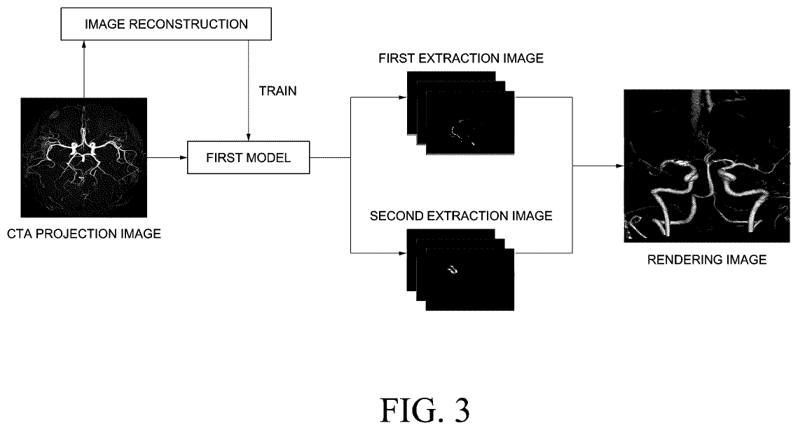

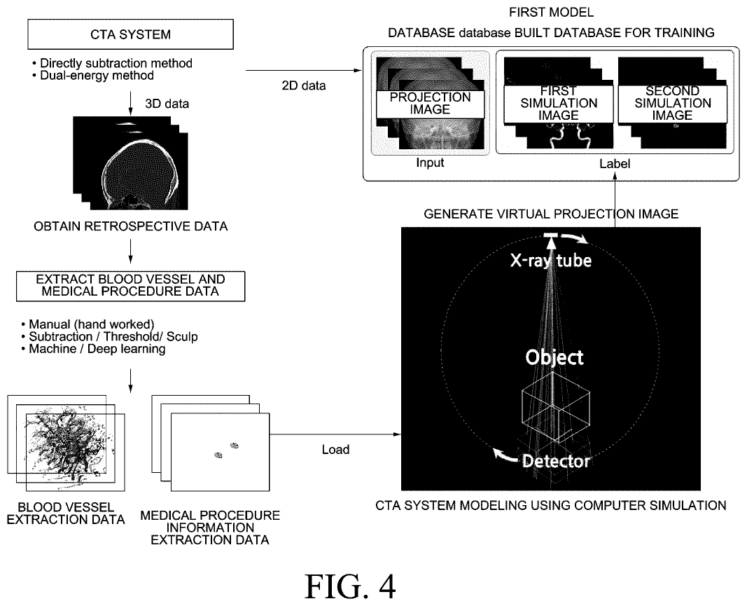

FIG. 3 is a schematic view for an information providing method for an angiography according to an exemplary embodiment of the present disclosure. At this time, for the convenience of description, the description will be made with reference to FIGS. 4 to 6.

Referring to FIG. 3, according to the present disclosure, a rendering image may be generated based on a CTA projection image.

First, the CTA projection image may be input to a first model. At this time, the CTA projection image may refer to a medical image derived from medical imaging equipment, such as a CT and various images which extract blood vessels may be used as well as the CT. The CTA projection image may be received from a medical institution or medical imaging equipment such as a CT to be used. Moreover, in the information providing method for angiography according to the exemplary embodiment of the present disclosure, the received CTA projection image may be a single-imaged image after injecting a contrast agent but is not limited thereto. For example, as the received CTA projection image of the present disclosure, a medical image of the related art which is imaged twice or more to be recorded may also be used, but desirably, an image single-imaged after injecting a contrast agent may be used.

In the meantime, the CTA image may be used not only to generate a rendering image, but also to train the first model.

To be more specific, referring to FIG. 4, a schematic view for model training data in an information providing method for an angiography according to an exemplary embodiment of the present disclosure is illustrated.

The learning data of the present disclosure may include virtual projection image data derived from the received CTA projection image.

First, the received CTA projection image is an image derived by a CTA imaging technique, such as directly subtraction method and a dual energy-based material separation method (dual-energy method) and may refer to retrospective data stored within a medical institution or medical imaging equipment. Moreover, the received CTA projection image may include not only images, but also data (data about blood vessel and medical procedure) related to this. Moreover, the CTA system may generate 2D and 3D images so that retrospective CTA projection images may include all the 2D and 3D images which are stored in the medical institution or the medical imaging equipment. As a result, the CTA projection image used to train the model may be not only an image for a specific individual, but also images for one or more various individuals stored in the medical institution or the medical imaging equipment but is not limited thereto. As a result, the received CTA projection image may include one or more projection images, and one or more virtual projection images may be generated based on the received CTA projection image.

The received CTA projection image may be selected by identifying whether blood vessel and medical procedure information in the image is lost or distorted and learning data for model training, that is, a simulation image may be derived based on a complete CTA projection image which does not include loss or distortion of blood vessel and medical procedure information. Moreover, the CTA projection image received to derive a simulation image may be 3D image data to extract 3D blood vessel non-medical procedure data but is not limited thereto.

Next, blood vessel and medical procedure data are extracted (separated) from the selected CTA projection image. At this time, as the extracting method, a hand worked method, a subtraction method, a threshold method, and a machine (deep) learning method may be used. For example, when the received CTA projection image is an image set indicating presence/absence of a contrast agent, the blood vessel and medical procedure data may be extracted by means of the subtraction depending on presence/absence. Moreover, in the case of the CTA projection image based on the dual energy method, after removing data about the bone from the CTA projection image, a threshold suitable for blood vessel and high-density medical procedure data is applied to extract data. Moreover, the extracted blood vessel and medical procedure data may be 3D image data.

Thereafter, the extracted blood vessel data and medical procedure data are applied to the computer simulation with the same condition as the actual CTA system to be derived (acquired) as various simulation images, that is, digital reconstructed radiography (DRR). To be more specific, the extracted blood vessel data is applied to the computer simulation modeling for the CTA system to generate at least one or more first simulation images (virtual blood vessel projection images) for the blood vessel data. Likewise, the extracted medical procedure data is also applied to the computer simulation modeling for the CTA system to generate at least one or more second simulation images (virtual medical procedure information projection images) for the medical procedure data. At this time, the computer simulation is a method for predicting a behavior of an actual system using a model and may be modeled by computer simulation software. For example, the computer simulation model of the present disclosure is software to which radiation physics is applied and may be based on a mathematical probabilistic algorithm such as the Monte Carlo method, and may be a simulator such as GEANT4, EGS4, MCNP, and FLUKA, but is not limited thereto.

Therefore, according to the present disclosure, the computer simulation modeling may acquire CTA projection images in various cases only with a minimum CTA projection image and may construct various databases for machine learning (training) based on this. Unlike an actually measured projection image, the simulation image acquired by the computer simulation modeling may be an image from which data error, loss, and distortion are excluded. That is, the computer simulation modeling provides a plurality of cleaned data so that more accurate model training may be possible.

Next, in the model training, in order to improve the accuracy for a target object, that is, blood vessel and medical procedure data, a masking step may be further included. To be more specific, the first simulation image and the second simulation image generated by the computer modeling may be 3D data. Therefore, in the present disclosure, a step of generating (converting) the 3D first simulation and second simulation images to the 2D data again, converting the generated 2D data into a binary image, and generating an extraction map from the converted binary image may be further included. That is, according to the present disclosure, in order to avoid interference with the training of the model, data excluding target blood vessel and medical procedure data may be masked. As a result, the present disclosure further includes a masking step so that the model may more clearly learn the target blood vessel and medical procedure data.

Next, the generated first simulation and second simulation images may be used to train the model as pair data, together with raw data. At this time, the raw data may be a CTA projection image, which is 2D image data when the first simulation and second simulation images are derived (generated) but is not limited thereto and 3D image data may be used. Desirably, the raw data may be a 2D CTA projection image.

In the meantime, the present disclosure may further include a masking step as described above. The masking step may not be included as needed. However, when the masking step is included, the first simulation and second simulation images are generated as the 2D extraction map so that the first model may be trained based on the received CTA projection image (raw data) and respective extraction maps.

According to the above-described process, the first model of the present disclosure is trained based on the first simulation and the second simulation for the blood vessel data and the medical procedure data and may generate a projection image for a blood vessel and a projection image for medical procedure data from the CTA projection image based on this. That is, the first model may be a model which is trained to generate a first extraction image for a blood vessel with the CTA projection image as an input and the first model may be a model trained to generate a second extraction image for medical procedure data with the CTA projection image as an input but is not limited thereto.

Moreover, according to the present disclosure, a plurality of learning databases is constructed from a minimum amount of data (CTA projection images) without being limited to personal information and other regulations (restrictions) and the first model may be trained based on the database.

Referring to FIG. 3 again, the CTA projection image is input to the first model to be generated as a first extraction image (blood vessel projection image) for a blood vessel and a second extraction image (medical procedure data projection image) for medical procedure data and the rendering image may be generated based on the respective generated extraction images.

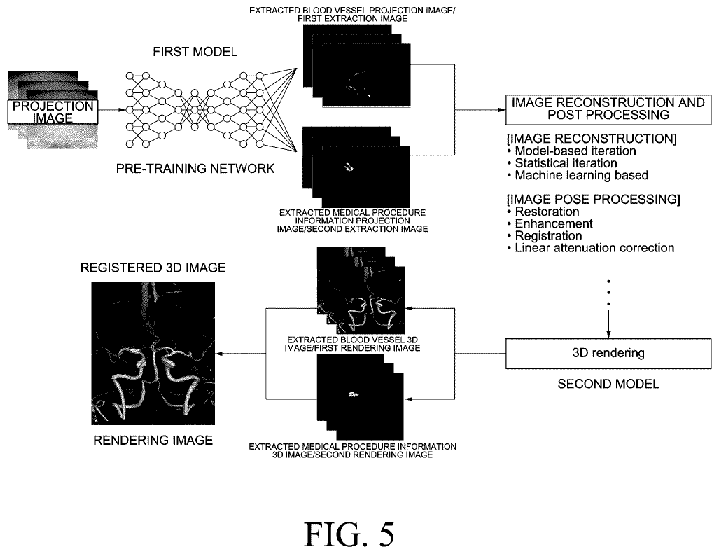

To be more specific, referring to FIG. 5, a schematic view for rendering image generation in an information providing method for an angiography according to an exemplary embodiment of the present disclosure is illustrated.

The CTA projection image is input to the first model which is previously trained (learned) as described above in FIG. 4 to be generated as the first extraction image (extracted blood vessel projection image) and the second extraction image (extracted medical procedure information projection image).

First, the first model is trained to generate a first extraction image (blood vessel projection image) for a blood vessel with the CTA projection image as an input so that CTA projection image is input to the first model to be generated as a first extraction image (blood vessel projection image) for a blood vessel. Similar to this, the first model is trained to generate a second extraction image (medical procedure information projection image) for medical procedure data with the CTA projection image as an input so that CTA projection image is input to the first model to be generated as a second extraction image (medical procedure information projection image) for medical procedure data.

Next, the generated first extraction image and second extraction image are subject to the image reconstruction and the post processing process to be generated as rendering images. To be more specific, according to the present disclosure, 3D first rendering image and second rendering image may be generated based on the first extraction image and the second extraction image, respectively. The generation, that is, the reconstruction method may be based on at least one of analytic method-based filtered back-projection (FBP), iterative method-based algebraic reconstruction technique (ART), statistical method-based maximum likelihood expectation maximization (ML-EM), and machine learning method-based automap, but is not limited thereto.

However, desirably, the method for generating a rendering image in the information providing method for angiography according to the exemplary embodiment of the present disclosure may be a machine learning method, such as automap. Therefore, the first extraction image and the second extraction image are input to the second model to be generated as a first rendering image for a blood vessel and a second rendering image for medical procedure data. At this time, the second model may be a model trained to generate a rendering image with the first extraction image as an input, that is, a first rendering image for a blood vessel and in addition, the second model may be a model trained to generate a second rendering image for medical procedure data with the second extraction image as an input, but is not limited thereto.

In the meantime, according to the present disclosure, the image quality of the rendering image may be corrected (enhanced) along with the generation of the rendering image. To be more specific, the generated rendering image may be subject to at least one of restoration, enhancement, registration, and linear attenuation correction, as post processing to improve the image quality. Therefore, according to the present disclosure, clearer and more distinct 3D images for the blood vessel and medical procedure data may be generated.

Next, the generated first rendering image and second rendering image are registered to be generated as a final 3D rendering image. To be more specific, the final rendering image is an image including both the blood vessel and medical procedure data and the first rendering image and the second rendering image match to allow the correlation of the blood vessel and the medical procedure data to be identified at once.

In the meantime, when there is no medical procedure record for the blood vessel of the individual, the second extraction image and the second rendering image for the medical procedure data may not be included so that the first rendering image for the blood vessel may be a final rendering image.

As a result, according to the present disclosure, through the above-described process, a 3D rendering image may be generated from the single-imaged CTA projection image. At this time, the generated 3D rendering image is generated based on the machine learning method which is trained based on a plurality of simulation images derived by the computer simulation so that the correction for the beam hardening which is the limitation of the imaging method of the related art is overcome to provide a more accurate and reliable 3D image.

Referring to FIG. 3 again, the present disclosure may generate and provide simulation images for various cases, extraction images and rendering images for blood vessel and medical procedure data, from single-imaged projection images, by means of the above-described processes of FIGS. 4 and 5.

In the meantime, the information providing method for angiography according to the exemplary embodiment of the present disclosure may be embodied in various forms without being limited to the above description.

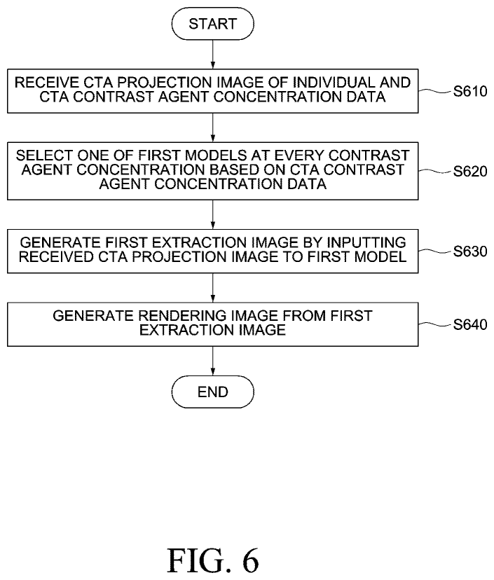

First, FIG. 6 is a flowchart for an information providing method for an angiography according to another exemplary embodiment of the present disclosure for reduction of a contrast agent.

Referring to FIG. 6, an information providing method for angiography to reduce a contrast agent according to an exemplary embodiment of the present disclosure is an information providing method for angiography to reduce a contrast agent which is performed by a processor and may include a step S610 of receiving a computed tomography angiography (CTA) projection image of an individual and CTA contrast agent concentration data, a step S620 of selecting one of first models at every contrast agent concentration trained to generate a first extraction image for a blood vessel with a projection image for CTA as an input based on the contrast agent concentration data, a step S630 of generating a first extraction image by inputting the received projection image to the selected first model, and a step of generating a rendering image from the first extraction image.

Further, in the receiving step S610, the CTA projection image may refer to a 2D projection image obtained by imaging an X-ray-based CTA but is not limited thereto and may include all various medical images from which the blood vessel can be extracted. Moreover, the CTA projection image may refer to a projection image single-imaged after injecting a contrast agent. Generally, an imaging technique based on the CTA projection image of the related art is performed based on two CT images acquired by secondary imaging, after injecting the contrast agent, which causes double covering due to the secondary imaging. Moreover, according to the method of the related art, during the secondary imaging time, if the individual moves, it may cause an artifact. However, a 3D blood vessel image (3D rendering image) including accurate blood vessel information may be generated by single imaging when a contrast agent according to the exemplary embodiment of the present disclosure shows a maximum contrast enhancement in a region of interest. Moreover, the contrast agent for the CTA projection image in the present disclosure may have a low concentration. Generally, a reference contrast agent concentration of the related art which is used for the CTA system causes damage to a skin or gastrointestinal tract and may lead fatal reactions such as anaphylaxis. Therefore, in the present disclosure, a CTA projection image is acquired based on the contrast agent concentration which is 90% or lower of the reference contrast agent concentration and the 3D rendering image is generated based on this so that the side effect of the related art according to the contrast agent concentration may be overcome. At this time, the contrast agent has a different reference concentration due to various conditions, such as individuals, components of the contrast agent, and a manufacturer of the contrast agent. Therefore, the contrast agent concentration of the present disclosure may be 90% or lower of the reference concentration, which is generally used by a medical staff, and desirably 50% or lower.

Next, in the selecting step S620, the first model is a model trained to generate a first extraction image for a blood vessel with the projection image for CTA as an input and is provided at every contrast agent concentration. For example, the first model may include at least one of a first model of a contrast agent concentration of 0%, a first model of a contrast agent concentration of 10%, a first model of a contrast agent concentration of 20%, a first model of a contrast agent concentration of 30%, a first model of a contrast agent concentration of 40%, a first model of a contrast agent concentration of 50%, a first model of a contrast agent concentration of 60%, a first model of a contrast agent concentration of 70%, a first model of a contrast agent concentration of 80%, a first model of a contrast agent concentration of 90%, and a first model of a contrast agent concentration of 100%, but is not limited thereto. Accordingly, according to the present disclosure, a specific first model corresponding to received CTA contrast agent concentration data may be selected and the specific first model is trained to be specified for a specific concentration so that the reliability and the accuracy may be higher than that of a model which is trained based on various contrast agent concentration data.

Moreover, the first model is a machine learning method so that the learning based on various prior data may be required. Therefore, according to the present disclosure, in order to train the first model, a learning step may be included prior to the selecting step S620.

To be more specific, the first model may be trained based on a simulation image for blood vessel data and a dataset including the same. First, the present disclosure may further include, prior to the selecting step S620, a step of generating a second extraction image for a blood vessel from a received CTA projection image, a step of acquiring a thickness of a blood vessel from the second extraction image, a step of generating a third extraction image at every contrast agent concentration from the second extraction image by converting an image intensity of the second extraction image based on the blood vessel thickness, a step of generating a simulation image for at least one or more contrast agent concentrations, by applying the third extraction image at every contrast agent concentration to computer simulation for the CTA system, a step of generating a first dataset at every contrast agent concentration by matching the received CTA projection image to each simulation image at every contrast agent concentration, and a step of training the first model at every contrast agent concentration based on the first dataset at every contrast agent concentration. At this time, the extracted blood vessel data, that is, the second extraction image, may refer to a 3D image, but is not limited thereto and may include all data related to the blood vessel extracted from the CTA projection image.

The step of generating a second extraction image may include a step of applying a threshold value after removing data for a bone in the received CTA projection image. To be more specific, when the received CTA projection image is an image generated from a dual energy CT, information about a bone having an image intensity similar to that of the contrast agent may not be completely removed and the medical procedure information about the high-density material, such as metal may be lost due to beam hardening. Therefore, the present disclosure may include a step of extracting the medical procedure information about the high-density material, such as a metal material by removing the bone and applying a threshold value. Accordingly, the present disclosure includes a step of applying the threshold value after removing data about the bone in the received CTA projection image described above, so that various CTA projection images may be used without being restricted by the CT imaging method.

The step of acquiring a blood vessel thickness may include a step of measuring a blood vessel thickness in the second extraction image in one or more side directions, and a step of calculating an average value for the one or measured blood vessel thicknesses. At this time, when the blood vessel thickness is measured, various blood vessel regions may be measured, rather than one time measurement of a specific part. To be more specific, the blood vessel data in the second extraction image may be 3D data and the thickness of the blood vessel data in the second extraction image may be measured. First, as the blood vessel data, the blood vessel thickness may be measured based on a transversal side surface and may be measured in one or more side directions. The one or more measured blood vessel thicknesses are calculated as an average value and the calculated average value may be used as a final blood vessel thickness. At this time, the thickness of the blood vessel may be calculated for every blood vessel region so that one or more blood vessel thicknesses may be obtained.

The step of generating a third extraction image may include a step of selecting at least one or more of predetermined transformation formulas at every blood vessel thickness based on the blood vessel thickness and a step of generating a third extraction image at every contrast agent concentration from the second extraction image by applying at least one selected transformation formula to the second extraction image.

Moreover, as the transformation formula, a transformation formula corresponding to a corresponding thickness may be selected based on the measured blood vessel thickness. As the transformation formula includes correlation (percentage) of the image intensity according to the contrast agent concentration at every thickness, when the transformation formula is applied to the second extraction image, an image at every contrast agent concentration whose image intensity is converted may be generated.

In the meantime, the transformation formula is determined in advance to be fixed at every thickness and may be derived by the calibration phantom. That is, the predetermine transformation formula at every blood vessel thickness of the present disclosure is a transformation formula calculated based on the CTA projection image for a calibration phantom. At this time, the calibration phantom of the present disclosure is a tool which represents blood vessels of various thicknesses in the body and is configured by acryl and aluminum. The acryl may be an equivalent material which represents soft tissue, and the aluminum may be an equivalent material which represents hard tissue, that is, a bone, but are not limited thereto.

In the step of generating a third extraction image, the third extraction image may be an image in which the received CTA projection image is registered on each third extraction image at every concentration.

The step of generating a simulation image may further include a step of generating the simulation image as 2D data, a step of converting the 2D data into a binary image, and a step of generating an extraction map from the binary image. At this time, the computer simulation refers to a simulation which implements the same environment (an irradiator, a detector, and an irradiation condition) as the actual medical imaging system and may generate a virtual projection image including 2D data or 3D data, based on the extracted blood vessel data. Moreover, in order to more clearly distinguish a target (blood vessel) in the virtual projection image, the virtual blood vessel projection image may be converted into a binary image, that is, an image configured by two values, such as black and white or 0 and 1. Therefore, according to the present disclosure, the target may be more clearly distinguished, and extracted to be generated as an extraction map.

As a result, the present disclosure includes steps for training the above-described first model, prior to the selecting step so that a plurality of training data may be easily acquired to allow the first model to be trained based on this to have high accuracy and reliability.

Next, in the step S630 of generating a first extraction image, a specific first model corresponding to the received CTA contrast agent concentration data is selected to generate a first extraction image from the CTA projection image. At this time, the first extraction image may be a projection image in which an image intensity for a blood vessel region is enhanced from the CTA projection image for a low concentration contrast agent. That is, the first model of the present disclosure includes a plurality of models which is trained based on various contrast agent concentrations so that the image intensity in the image is enhanced without being restricted to the contrast agent concentration for the received CTA projection image to generate a projection image for a blood vessel.

Next, in the step S640 of generating a rendering image, the rendering image may refer to a 3D graphic image having a three-dimensional effect generated by assigning shadow, color, and density in consideration of data, such as a shape, a position, and illumination of 2D data (image).

The step S240 of generating a rendering image may be based on at least one of filtered back-projection (FBP), algebraic reconstruction technique (ART), maximum likelihood expectation maximization (ML-EM), and an automap, but is not limited thereto and may include all various methods which convert a 2D image into a 3D image.

However, desirably, the step S640 of generating a rendering image of the present disclosure may be a step based on the machine learning method.

Therefore, the step S640 of generating a rendering image may further include a step of generating a rendering image for a blood vessel by inputting the first extraction image to the second learning model. At this time, the second learning model may be a model trained to generate a rendering image with the first extraction image as an input but is not limited thereto.

Data loss or errors may be generated while converting the rendering image so that the step S640 of generating a rendering image may further include a step of correcting the loss or error. That is, the step S640 of generating a rendering image may further include a step of correcting an image quality of a rendering image and at this time, the correction may include at least one of restoration, enhancement, registration, and linear correction, but is not limited thereto.

By these processes as described above, the information providing method for angiography to reduce a contrast agent according to an exemplary embodiment of the present disclosure may generate a blood vessel rendering image with a high quality based on the CTA image for a low concentration contrast agent. That is, according to the present disclosure, a side effect applied to an individual due to the contrast agent in the related art may be minimized.

Further, the present disclosure is based on the calibration phantom which represents blood vessels of various thicknesses in the body so that image intensity criteria for a blood vessel in various medical images may be provided to provide uniform medical image results.

Further, according to the present disclosure, medical image data and clinical data that are difficult to obtain due to many regulations and restrictions such as personal information protection may be easily obtained in various cases through the computer simulation. Therefore, according to the present disclosure, the machine learning model may be trained with a plurality of data obtained by the above-described computed simulation so that the machine learning model of the present disclosure may derive a result with a high reliability and accuracy.

In the meantime, the information providing method for angiography to reduce a contrast agent according to the exemplary embodiment of the present disclosure predict and provide not only a rendering image, but also a vascular disease of an individual based on the rendering image.

Therefore, the information providing method for angiography to reduce a contrast agent according to an exemplary embodiment of present disclosure may further include a step of receiving clinical data of an individual and further include a step of predicting a probability for a vascular disease of an individual based on the clinical data and the rendering image. At this time, the clinical data may refer to data including various examination results, prescription data, treatment records, and personal information about an individual stored within a medical institution.

To be more specific, a step of predicting a probability may include a step of extracting features in the rendering image and a step of predicting a probability for a vascular disease of an individual by inputting clinical data and features to a third model. At this time, the third model may be a model trained to predict a probability for a vascular disease of an individual with clinical data and features as inputs but is not limited thereto.

As a result, according to the present disclosure, a high-quality rendering image is generated and provided and prediction information for a vascular disease of an individual with a high accuracy and reliability may be provided based on this.

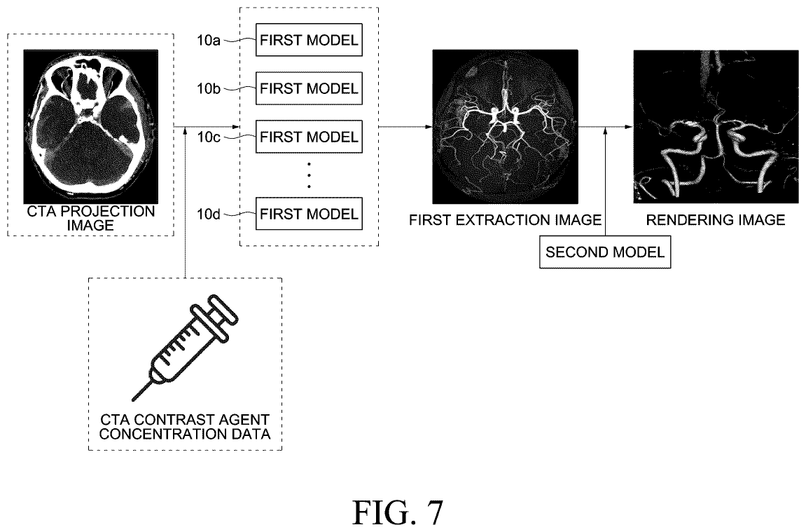

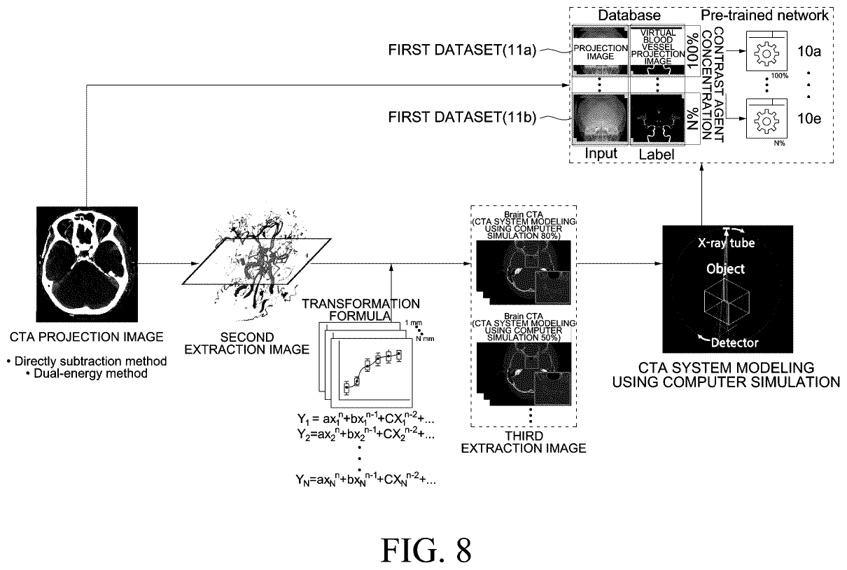

FIG. 7 is a schematic view for an information providing method for an angiography to reduce a contrast agent according to another exemplary embodiment of the present disclosure. At this time, for the convenience of description, the description will be made with reference to FIGS. 8 to 10.

Referring to FIG. 7, the information providing method for angiography to reduce a contrast agent according to the present disclosure inputs the CTA projection image to the first model to generate a first extraction image and generate a rendering image based on the generated first extraction image.

To be more specific, the CTA projection image may be input to any one of first models 10a, 10b, 10c, and 10d based on the CTA contrast agent concentration data. At this time, the CTA projection image may refer to a medical image derived from medical imaging equipment, such as a CT and various images which extract blood vessels may be used as well as the CT. The CTA projection image may be received from a medical institution or medical imaging equipment such as a CT to be used. Moreover, the CTA contrast agent concentration data may also be received in the same manner as the CTA projection image. Moreover, in the information providing method for angiography to reduce a contrast agent according to the exemplary embodiment of the present disclosure (hereinafter, the present disclosure), the received CTA projection image may be a single-imaged image after injecting a contrast agent but is not limited thereto. Further, the received projection image in the present disclosure may be an image which is imaged by injecting a low concentration contrast agent, and desirably, a concentration may be 90% or lower than a reference contrast agent concentration but is not limited thereto. Moreover, as the received CTA projection image of the present disclosure, a medical image of the related art which is imaged twice or more to be recorded may also be used, but desirably, an image single-imaged after injecting a contrast agent may be used.

The first model may include first models 10a, 10b, 10c, and 10d for contrast agent concentrations and is trained to generate a first extraction image with the projection image for CTA as an input.

With regard to this, referring to FIG. 7, a schematic view for a learning process of a first model in an information providing method for an angiography to reduce a contrast agent according to an exemplary embodiment of the present disclosure is illustrated.

The first model of the present disclosure may be trained based on learning data generated from the CTA projection image, that is, based on the first datasets 11a and 11b.

First, a second extraction image for a blood vessel may be generated from the CTA projection image. At this time, the CTA projection image used to generate the learning data is an image generated by a CTA imaging technique, such as directly subtraction method and a dual energy-based material separation method (dual-energy method) and may be the same as the CTA projection image which is input to the first model in FIG. 7 described above, but is not limited thereto and may be retrospective data stored within a medical institution or medical imaging equipment. Moreover, the CTA projection image may include not only images, but also data (data about blood vessel and contrast agent concentration) related to this. Moreover, the CTA system may generate 2D and 3D images so that retrospective CTA projection images may include all the 2D and 3D images which are stored in the medical institution or the medical imaging equipment. As a result, the CTA projection image used to generate learning data may be not only an image for a specific individual, but also images for one or more various individuals stored in the medical institution or the medical imaging equipment but is not limited thereto. As a result, the received CTA projection image used to generate learning data may include one or more CTA projection images and one or more virtual projection images may be generated based on this.

Moreover, the method for generating a second extraction method, that is, a method for extracting blood vessel data in a CTA projection image may be based on hand worked, subtraction, threshold, and machine (deep) learning methods. For example, when the received CTA projection image is an image set indicating presence/absence of a contrast agent, the blood vessel data may be extracted by means of the subtraction depending on presence/absence. Moreover, in the case of the CTA projection image based on the dual energy method, after removing data about the bone from the CTA projection image, a threshold suitable for blood vessel data is applied to extract data. Moreover, the extracted blood vessel and medical procedure data may be 3D image data.

Next, the blood vessel thickness may be obtained from the generated second extraction image. To be more specific, the blood vessel data in the second extraction image may be 3D data and the thickness of the blood vessel data in the second extraction image may be measured. First, as the blood vessel data, the blood vessel thickness may be measured based on a transversal side surface and may be measured in one or more side directions. The one or more measured blood vessel thicknesses are calculated as an average value and the calculated average value may be used as a final blood vessel thickness. At this time, the thickness of the blood vessel may be calculated for every blood vessel region so that one or more blood vessel thicknesses may be obtained.

Next, a transformation formula corresponding to the thickness is selected based on the calculated final blood vessel thickness and a selected transformation formula may be applied to the second extraction image. Therefore, the image intensity for the blood vessel data in the second extraction image is converted to generate a third extraction image from the second extraction image. At this time, as the transformation formula includes correlation (percentage) of the image intensity according to the contrast agent concentration at every thickness, when the transformation formula is applied to the second extraction image, an image at every contrast agent concentration whose image intensity is converted may be generated.

In the meantime, the transformation formula is determined in advance to be fixed at every thickness and may be derived by the calibration phantom.

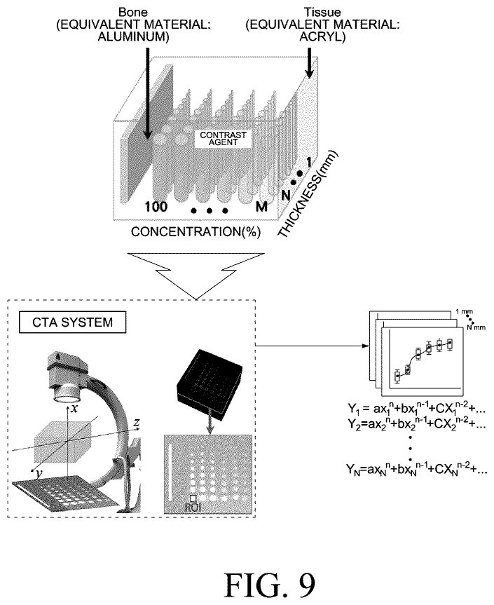

To be more specific, referring to FIG. 9, a schematic view for a calibration phantom and a transformation formula thereof used in an information providing method for an angiography to reduce a contrast agent according to another exemplary embodiment of the present disclosure is illustrated.

The transformation formula used for the present disclosure may be derived by the calibration phantom. The calibration phantom is a tool which evaluates and calibrates the performance of medical imaging equipment, such as CT and MRI and the equipment which represents a human body is inserted to set measurement criteria. The calibration phantom of the present disclosure is a tool which represents blood vessels of various thicknesses in the body and is configured by acryl and aluminum. The acryl is an equivalent material which represents soft tissue, and the aluminum is an equivalent material which represents hard tissue, that is, a bone, but are not limited thereto.

The calibration phantom of the present disclosure includes a cylindrical groove with a diameter of 1 to 100 mm in an acrylic frame and the contrast agent may be injected through the groove. At this time, the grooves may be disposed in a matrix but is not limited thereto. For example, for the convenience of user, the grooves of the calibration phantom of the present disclosure may be freely disposed in the acrylic frame in various forms, such as 3×3, 4×4, or M×N.

Moreover, the calibration phantom of the present disclosure includes a structure which is spaced apart from the groove and is configured by aluminum. As described above, the structure configured by aluminum may represent bones which are hard tissues in the body and may be formed to have a predetermined interval from the groove so as not to interrupt the groove including a contrast agent. The structure configured by aluminum is formed as a small rectangular column to be differentiated from the groove but is not limited thereto and may be configured in various shapes, such as the same shape as the groove. That is, the calibration phantom of the present disclosure includes a groove which represents blood vessels having various sizes and a structure which represents bones so that the contrast agent is injected into the groove and is imaged with an actual CT to compare relative image intensity values in the blood vessel and the bone. At this time, the contrast agent may be injected with various concentrations so that image intensity data according to various blood vessel thicknesses and contrast agent concentrations may be obtained from the calibration phantom of the present disclosure.

The CT imaging of the calibration phantom is performed in the same condition and environment as the CTA imaging of an actual patient and may obtain a CTA projection image for the calibration phantom. The same method (algorithm and parameter) as the generation of the second extraction image from the CTA projection image of the individual in FIG. 8 is applied to the CTA projection image for the acquired calibration phantom so that an extraction image (hereinafter, a calibration phantom extraction image) for a groove and an aluminum structure in the calibration phantom may be generated from the CTA projection image for the calibration phantom. Therefore, the image intensity data according to the contrast agent concentration at every thickness may be obtained from the generated calibration phantom extraction image and an equation is derived from a correlation function graph for a contrast agent concentration and an image intensity to be used for a transformation formula at every blood vessel thickness.

As a result, the present disclosure includes a transformation formula for the above-described calibration phantom of FIG. 9 so that the image intensity for a contrast agent may be transformed from the projection image for a blood vessel having various thicknesses.

Referring to FIG. 8 again, the above-described transformation formula in FIG. 9 is applied to the second extraction image to generate a third extraction image at every contrast agent concentration from the second extraction image. At this time, the third extraction image may be a 3D image for a blood vessel region, like the second extraction image, but is not limited thereto and may be a dataset generated by registering the converted data into the existing CTA projection image. Therefore, the third extraction image includes an image with the same structure and format as the CTA projection image and different contrast agent concentrations in the CTA projection image. That is, the third extraction image of the present disclosure may be a dataset including a CTA projection image at every contrast agent in which only the contrast agent concentration is different from that of the CTA projection image at every contrast agent concentration and a 3D blood vessel extraction image.

Thereafter, the third extraction image at every contrast agent concentration is applied to the computer simulation for the CTA system to be generated (acquired) as various simulation images, that is, digital reconstructed radiography (DRR). To be more specific, the third extraction image at every contrast agent concentration is applied to the computer simulation modeling for the CTA system to generate at least one or more simulation images (virtual blood vessel projection image) at every contrast agent concentration. At this time, the computer simulation is a method for predicting a behavior of an actual system using a model and may be modeled by computer simulation software. For example, the computer simulation model of the present disclosure is software to which radiation physics is applied and may be based on a mathematical probabilistic algorithm such as Monte Carlo method, and may be a simulator such as GEANT4, EGS4, MCNP, and FLUKA, but is not limited thereto.

Next, the CTA projection image matches each generated simulation image at every contrast agent concentration to generate a first dataset 11a and 11b at every contrast agent concentration and a first model 10a and 10e at every contrast agent concentration may be trained based on this. For example, the first model 10a based on the contrast agent concentration of 100% may be a model trained based on a simulation image with an image intensity of a contrast agent concentration of 100% and a first dataset 11a thereof and the first model 10e based on the contrast agent concentration of N % may be a model trained based on a simulation image with an image intensity of a contrast agent concentration of N % and a first dataset 11b thereof.

At this time, according to the present disclosure, in the model training, in order to improve accuracy for a target object, that is, blood vessel data, a masking step may be further included. To be more specific, the simulation image at every contrast agent concentration generated by the computer modeling may be 3D data. Therefore, in the present disclosure, a step of generating (converting) the 3D simulation image to the 2D data again, converting the generated 2D data into a binary image, and generating an extraction map from the converted binary image may be further included. That is, according to the present disclosure, in order to avoid interference with the training of the model, data excluding target blood vessel data may be masked. As a result, the present disclosure further includes a masking step so that the model may more clearly learn the target blood vessel data. In the meantime, the present disclosure may further include a masking step as described above. The masking step may not be included as needed. However, when the masking step is included, the simulation image at every contrast agent concentration is generated as the 2D extraction map so that the first model may be trained based on a dataset based on the received CTA projection image (raw data) and respective extraction maps.

According to the above-described process, the first model of the present disclosure is trained based on a simulation image for blood vessel data at various contrast agent concentrations and may generate a projection image for a blood vessel at every contrast agent concentration from the CTA projection image based on this. That is, the first model may be a model trained to generate a first extraction image for a blood vessel with a CTA projection image as an input and the first model may be present at every contrast agent concentration.

Moreover, according to the present disclosure, a plurality of learning databases is constructed from a minimum amount of data (CTA projection images) without being limited to personal information and other regulations (restrictions) and the first model may be trained based on the database.

Referring to FIG. 7 again, one of the first models 10a, 10b, 10c, and 10d is selected based on the received CTA contrast agent concentration data to input the received CTA projection image into a selected specific first model to generate a first extraction image. To be more specific, as described above in FIG. 9, the first model is provided at every contrast agent concentration and for example, the first model may include at least one of a first model 10d of a contrast agent concentration of 0%, a first model of a contrast agent concentration of 10%, a first model of a contrast agent concentration of 20%, a first model of a contrast agent concentration of 30%, a first model of a contrast agent concentration of 40%, a first model of a contrast agent concentration of 50%, a first model of a contrast agent concentration of 60%, a first model of a contrast agent concentration of 70%, a first model 10c of a contrast agent concentration of 80%, a first model 10b of a contrast agent concentration of 90%, and a first model 10a of a contrast agent concentration of 100%. Therefore, the first model corresponding to the received CTA contrast agent concentration is selected to generate a first extraction image from the CTA projection image. At this time, the first extraction image may be a projection image for a blood vessel in which an image intensity for a blood vessel region is augmented (enhanced) from the CTA projection image based on a low concentration contrast agent.

Next, the rendering image may be generated from the first extraction image. At this time, the rendering image may be generated by inputting the first extraction image to a second model trained to generate a rendering image with the first extraction image as an input. At this time, the first extraction image may be subject to at least one of restoration, enhancement, registration, and linear attenuation correction, as post processing to improve the image quality. After applying this, a process of generating the rendering image may be performed. Therefore, according to the present disclosure, clearer and more distinct 3D images for the blood vessel and medical procedure data may be generated. Further, the rendering image is based on the first extraction image which is a projection image for a blood vessel so that it may be a rendering image for a blood vessel (blood vessel region).

Moreover, according to the present disclosure, a 3D rendering image may be generated based on the first extraction image. The generation, that is, the reconstruction method may be based on at least one of analytic method-based filtered back-projection (FBP), iterative method-based algebraic reconstruction technique (ART), statistical method-based maximum likelihood expectation maximization (ML-EM), and machine learning method-based automap, but is not limited thereto. Most desirably, the method may be a method based on the machine learning method (second model) as described above.

As a result, according to the present disclosure, through the above-described process, a 3D rendering image may be generated from the CTA projection image for a contrast agent of a low concentration. At this time, the generated 3D rendering image is generated based on the machine learning method which is trained based on a simulation image at every concentration generated by the computer simulation to provide a more accurate and reliable 3D image without being restricted to the contrast agent concentration.

In the meantime, the information providing method for angiography to reduce a contrast agent according to the exemplary embodiment of the present disclosure not only generates an image, but also predicts and provides a prevalence probability for a vascular disease of an individual based on the image.

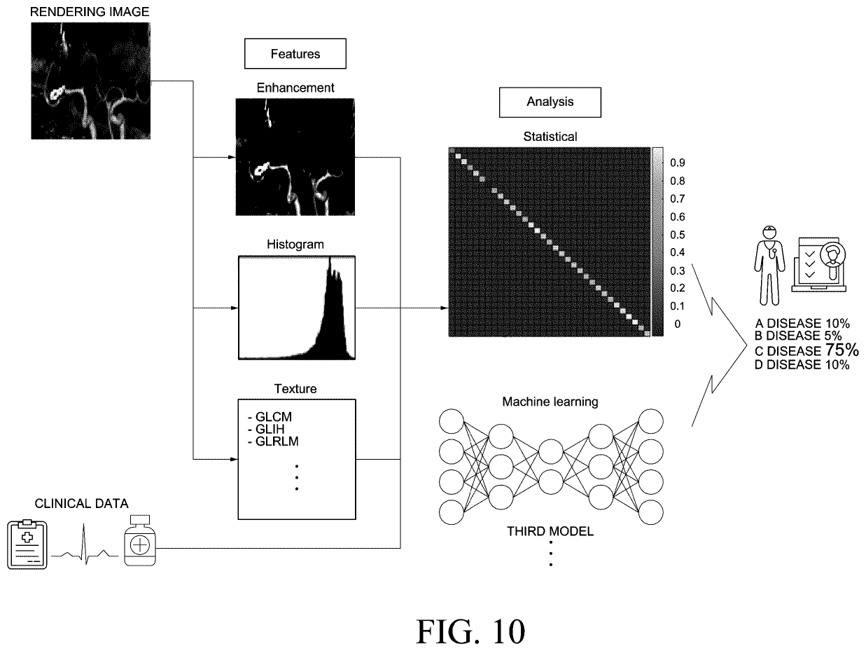

To be more specific, referring to FIG. 10, a schematic view for vascular disease prediction in an information providing method for an angiography to reduce a contrast agent according to an exemplary embodiment of the present disclosure is illustrated.

The vascular disease prediction of the present disclosure may be based on a 3D rendering image (final rendering image) and clinical data. At this time, the clinical data may be received from a medical institution and a server thereof together with the CTA projection image but is not limited thereto.

In the prediction of the vascular disease of the present disclosure, the feature of the rendering image is extracted to be used to predict a vascular disease of the individual. To be more specific, features in the rendering image may include various image processing conditions and may include features in the image, such as enhancement, histogram, texture, but is not limited thereto and may include all various element features used for image processing. For example, features in the rendering image used to predict a vascular disease of the present disclosure may include all an image model (pixel value expression method), sampling, quantization, a storage amount of digital image signal, storage formats (bmp, pcx, tiff, gif, jpg, png) of a digital image signal, pixel value transformation, spatial area transformation (filtering), mapping, affine transformation, interpolation, nonlinear warping, frequency transformation, point processing, spatial processing, frequency transform processing, morphology, image segmentation, edge expression, area expression, and image compression, but is not limited thereto.

Such features in the image may be extracted based on the above-described parameter, but are not limited thereto and various methods, such as a first order and second order-based probabilistic method, a transform-based feature extracting method may be applied.

Moreover, in order to extract a significant feature, among features extracted by the above-described method, a dimension may be reduced and LASSO, ridge, elastic net, machine learning, and hand washed method may be applied, but is not limited thereto and most desirably, a machine learning method (third model) may be applied.

In the case of the machine learning model (third model), an input terminal may be input as a multi-channel. Further, features which are input to the machine learning model may be subject to image augmentation pre-processing, such as linear transformation, distortion method, and domain transformation, but are not limited thereto. Further, the input signals may be normalized so that a problem of the local minima is reduced to improve the training speed of the machine learning model.

Moreover, a layer, such as class activation mapping (CAM) is added to a training model to derive a result so that result derivation may be explained. That is, the third model of the present disclosure may be explainable artificial intelligence (XAI) but is not limited thereto.

As a result, the information providing method for angiography to reduce a contrast agent according to the exemplary embodiment of the present disclosure may further receive clinical data of an individual and predict and provide incidence or prevalence probability for a vascular disease based on the generated rendering image and the received clinical data. Moreover, the generated rendering image may be used by extracting features thereof and for example, when the machine learning model is used to predict a probability for vascular disease, features in the rendering image are extracted and the clinical data and the feature are input to the third model to predict a probability for a vascular disease for an individual. At this time, the third model may be a model trained to predict a probability for a vascular disease of an individual with clinical data and extracted features as inputs.

Therefore, according to the present disclosure, not only the rendering image for the blood vessel, but also information about related vascular disease is provided to assist the medical staff to improve a diagnosis accuracy.

Although the exemplary embodiments of the present disclosure have been described in detail with reference to the accompanying drawings, the present disclosure is not limited thereto and may be embodied in many different forms without departing from the technical concept of the present disclosure. Accordingly, the various exemplary embodiments disclosed herein are not intended to limit the technical spirit of the present disclosure but describe with the true scope and spirit being indicated by the following claims and the scope of the technical spirit of the present disclosure is not limited to the exemplary embodiments. Thus, it is to be appreciated that exemplary embodiments described above are intended to be illustrative in every sense, and not restrictive. The protective scope of the present disclosure should be construed based on the following claims, and all the technical concepts in the equivalent scope thereof should be construed as falling within the scope of the present disclosure.

What is claimed is:

1. An information providing method for angiography which is implemented by a processor, comprising:
a step of receiving a projection image of a computed tomography angiography (CTA) of an individual;
a step of generating a first extraction image for a blood vessel by inputting the received CTA projection image to a first model which is trained to generate the first extraction image for the blood vessel with the CTA projection image as an input; and
a step of generating a rendering image from the first extraction image.

2. The information providing method for angiography according to claim 1, further comprising:
prior to the step of generating a first extraction image,
a step of extracting blood vessel data from the received CTA projection image;
a step of generating at least one or more first simulation images for the blood vessel data by applying the blood vessel data to a computer simulation for a CTA system; and
a step of training the first model based on the received CTA projection image and the first simulation image.

3. The information providing method for angiography according to claim 2, wherein the extracting step includes:
a step of applying a threshold value after removing data for a bone in the received CTA projection image.

4. The information providing method for angiography according to claim 2, wherein the step of generating a first simulation image further includes:
a step of generating the first simulation image as 2D data;
a step of converting the 2D data into a binary image; and
a step of generating an extraction map from the binary image.

5. The information providing method for angiography according to claim 4, wherein the step of training a first model further includes:
a step of training the first model based on the received CTA projection image and the extraction map.

6. The information providing method for angiography according to claim 1, further comprising:
prior to the step of generating a first extraction image,
a step of extracting medical procedure data from the received CTA projection image;
a step of generating at least one or more second simulation images for the medical procedure data by applying the medical procedure data to a computer simulation for a CTA system; and
a step of training the first model based on the received CTA projection image and the second simulation image.

7. The information providing method for angiography according to claim 1, wherein the step of generating a first extraction image further includes:
a step of generating a second extraction image for medical procedure data by inputting the received CTA projection image to the first model which is trained to generate the second extraction image for the medical procedure data with the CTA projection image as an input.

8. The information providing method for angiography according to claim 7, wherein the step of generating the rendering image further includes:
a step of generating the rendering image from the first extraction image and the second extraction image.

9. The information providing method for angiography according to claim 8, wherein the step of generating the rendering image includes:
a step of generating a first rendering image and a second rendering image by inputting the first extraction image and the second extraction image to a second model trained to generate the rendering images with the first extraction image and the second extraction image as inputs; and
a step of registering the generated first rendering image and second rendering image.

10. The information providing method for angiography according to claim 1, wherein the step of generating the rendering image includes:
a step of generating the rendering image for the blood vessel by inputting the first extraction image to a second model which is trained to generate the rendering image with the first extraction image as an input.

11. An information providing method for angiography to reduce a contrast agent which is implemented by a processor, comprising:
a step of receiving a computed tomography angiography (CTA) projection image of an individual and CTA contrast agent concentration data;
a step of selecting one of first models at every contrast agent concentration trained to generate a first extraction image for a blood vessel with the projection image for CTA as an input based on the contrast agent concentration data;
a step of generating the first extraction image by inputting the received projection image to the selected first model, and
a step of generating a rendering image from the first extraction image.

12. The information providing method for angiography to reduce a contrast agent according to claim 11, further comprising:
a step of receiving clinical data of the individual.

13. The information providing method for angiography to reduce a contrast agent according to claim 11, further comprising:
a step of predicting a probability for a vascular disease of the individual based on the clinical data and the rendering image.

14. The information providing method for angiography to reduce a contrast agent according to claim 11, wherein the contrast agent concentration is 90% or lower of a reference contrast agent concentration.

15. The information providing method for angiography to reduce a contrast agent according to claim 11, wherein the first model for every contrast agent concentration is at least one of a first model of a contrast agent concentration of 0%, a first model of a contrast agent concentration of 10%, a first model of a contrast agent concentration of 20%, a first model of a contrast agent concentration of 30%, a first model of a contrast agent concentration of 40%, a first model of a contrast agent concentration of 50%, a first model of a contrast agent concentration of 60%, a first model of a contrast agent concentration of 70%, a first model of a contrast agent concentration of 80%, a first model of a contrast agent concentration of 90%, and a first model of a contrast agent concentration of 100%.

16. The information providing method for angiography to reduce a contrast agent according to claim 11, further comprising:
prior to the selecting step,
a step of generating a second extraction image for the blood vessel from the received CTA projection image,
a step of acquiring a thickness of the blood vessel from the second extraction image;
a step of generating a third extraction image at every contrast agent concentration from the second extraction image by converting an image intensity of the second extraction image based on a blood vessel thickness;
a step of generating a simulation image for at least one or more contrast agent concentrations, by applying the third extraction image at every contrast agent concentration to a computer simulation for a CTA system;
a step of generating a first dataset at every contrast agent concentration by matching the received CTA projection image to each simulation image at every contrast agent concentration; and
a step of training the first model at every contrast agent concentration based on the first dataset at every contrast agent concentration.

17. The information providing method for angiography to reduce a contrast agent according to claim 16, wherein the step of generating a second extraction image includes:
a step of applying a threshold value after removing data for a bone in the received CTA projection image.

18. The information providing method for angiography to reduce a contrast agent according to claim 16, wherein the step of acquiring a blood vessel thickness includes:
a step of measuring the blood vessel thickness in the second extraction image in one or more side directions, and
a step of calculating an average value for the one or more measured blood vessel thicknesses.

19. The information providing method for angiography to reduce a contrast agent according to claim 16, wherein the step of generating a third extraction image includes:
a step of selecting at least one or more of predetermined transformation formulas at every blood vessel thickness based on the blood vessel thickness; and
a step of generating a third extraction image at every contrast agent concentration from the second extraction image by applying the at least one selected transformation formula to the second extraction image.

20. The information providing method for angiography to reduce a contrast agent according to claim 19, wherein the predetermined transformation formula at every blood vessel thickness is calculated based on the CTA projection image for a calibration phantom.
